(19) United States
(12) Patent Application Publication
(10) Pub. No.: US 2024/0135478 A1
(43) Pub. Date: Apr. 25, 2024

(54) SYSTEM AND METHOD FOR OBJECTIVE ASSESSMENT OF LEARNING OUTCOMES

(71) Applicant: Anastasia Maria Luca, Sacramento, CA (US)

(72) Inventor: Anastasia Maria Luca, Sacramento, CA (US)

(21) Appl. No.: 18/544,109

(22) Filed: Dec. 18, 2023

Related U.S. Application Data
(63) Continuation of application No. 18/165,324, filed on Feb. 6, 2023.
Application No. 18/165,324 is a continuation of application No. 17/376,712, filed on Jul. 15, 2021, now abandoned.
Application No. 17/376,712 is a continuation of application No. 16/882,832, filed on May 26, 2020, now abandoned.
Application No. 16/882,832 is a continuation of application No. 15/843,362, filed on Dec. 15, 2017, now abandoned.
Application No. 15/843,362 is a continuation of application No. 15/612,413, filed on Jun. 2, 2017, now abandoned.
Application No. 15/612,413 is a continuation of application No. 14/117,626, filed on Nov. 13, 2013, now abandoned.
(60) Provisional application No. 61/518,946, filed on May 14, 2011.

(51) Int. Cl. G06Q 50/20; G06Q 10/0639; G09B 7/00

(52) U.S. Cl. CPC G06Q 50/205; G06Q 10/06393; G06Q 50/20; G09B 7/00

(57) ABSTRACT

A data repository comprising at least a hierarchical arrangement of a plurality of learning goals is disclosed, which is coupled to a computing system with a report generator subsystem, an analysis subsystem, a rules subsystem, and an application server subsystem The application server provides an administrative interface for viewing, editing, or deleting a plurality of learning goals and relationships between them, learning assessment tools, learning outcome reports, and learning indexes, and the rules engine performs a plurality of consistency checks to ensure alignment between and among learning goals, learning assessment tools, learning outcomes, and learning indexes.

### CROSS-REFERENCE TO RELATED APPLICATIONS

Priority is claimed in the application data sheet to the following patents or patent applications, each of which is expressly incorporated herein by reference in its entirety:
Ser. No. 18/165,324
Ser. No. 17/376,712
Ser. No. 16/882,832
Ser. No. 15/843,362
Ser. No. 15/612,413
Ser. No. 14/117,626
PCT/US12/37849
61/518,946

### BACKGROUND OF THE INVENTION

### Field of the Invention

The invention relates to the field of education, and more particularly to the field of automated systems for facilitating learning using objective assessment, measurement, and management of learning outcomes.

### Discussion of the State of the Art

Education is generally understood by all to be a core function or responsibility of societies, governments, families, and so forth. No one doubts the desirability of achieving as much education for each member of society as possible within limits resulting from economics and from individuals' characteristics (this is equally applicable to educating young people in traditional schools and to adult education, including worker training programs, corporate education, professional continuing education, and general adult education). Accordingly, a great deal of research has been carried out, and many generations of improvements have been made, in an effort to continuously improve the quality of educational systems and their performance in creating positive educational outcomes at all levels (that is, for individual learners, for classes, for schools, for school districts, for states, or for nations). As the Internet has emerged as a major force of change in modern society, education has not escaped its transformative power. New and exciting modes of educational delivery are being introduced at a rapid rate, culminating for example in the open courseware movement being led by leading universities such as Stanford and MIT.

One area where improvements in outcomes have not occurred as quickly as might be expected as a result of revolutionary enhancements in available means is that of assessing learning performance. For generations, learners have relied on grades to measure their performance and to achieve their educational goals (for example, by achieving sufficiently high grades to obtain acceptance into a desired institution of higher education) Similarly, educators have used grading schemes to send important messages concerning learners' performance and aptitude to learners, parents, administrators, and institutions. Despite the importance of grading in particular, and educational assessments in general, the assessment of educational performance of learners, cohorts, classes, and institutions is still carried out today in a largely subjective way. Assessments of learning performance (outcomes) are currently based upon grading by individuals and self-serving surveys. In consequence, learning assessments of learning performance (learning outcomes) tend to be biased and subjective. There is a critical need to improve and objectify assessment of learning performance.

Learning stakeholders, including for example the U.S. Department of Education and various accreditation entities or authorities, need objective measures to assess learning performance (or learning outcomes). Learning assessments must reliably determine extent of learning and content of learning, such as acquired skills, knowledge, and the like (i.e., what, and to what extent, learning goals have been (or have not been) met). The essentially subjective and biased (and often self-serving) nature of contemporary educational assessment methodologies means that it is difficult to meaningfully and consistently compare learning progress across political boundaries, or even across classes or between teachers within a single department of a single school.

What is needed is a system and associated methods that take advantage of the Internet and modern information technology to enable one or more analytical methods of objectively and consistently assessing learning outcomes at various levels, in various zones, and over various spans, in a way that supports extended and effective analysis of the resulting data to better understand and to improve learning processes and learning outcomes.

### SUMMARY OF THE INVENTION

Accordingly, the inventor has conceived and reduced to practice, in a preferred embodiment of the invention, a system and various methods for objective assessment of learning outcomes, which may comprise, in various embodiments, features such as automated grading, computer-assisted grading and learning goal assessment, communication of learning expectations to learners, learning goals processing, and so forth. Moreover, the inventor has devised methods, disclosed herein, for driving goals-driven learning performance, objectively measuring quantity and quality of learning. According to a preferred embodiment, a system for objective assessment of learning outcomes may comprise, among others, processes for establishing learning goals, processes for establishing learning expectations, processes for managing identifier information and conventional standards, processes for assessing learning using various assessment forms and rubrics, processes for conducting learning assessments, carrying out calculations of and storing learning indexes (achieved and missed learning in relation to learning goals) at various levels of granularity (including but not limited to learning output, units, levels, spans, zones, individuals, groups, across levels and units, across spans, etc.), aggregated learning assessment reports of achieved and missed learning based on learning goals established and communicated at various levels of granularity (including but not limited to learning output, units, levels, spans, zones, individuals per units, levels, groups per levels, spans, etc.), aggregated feedback reports at various levels of granularity (including but not limited to any configuration, such as individual, team, output level, unit, level, span, zone, across units, levels, history, etc.), learning improvement plans at various levels of granularity (including but not limited to, units, levels, spans, zones, individuals, learners, learning agents, instructors, groups, etc.), feedback learning loops, learning progress and improvement reports at various levels of granularity, learning project management tools, consistency checks among steps and within steps, and so forth. An important goal achieved by use of systems and methods according to the invention is the automated or computer-assisted, analytical and quantitative assessment of learning outcomes driven by a plurality of learning goals and (optionally) by a plurality of learning expectations.

According to a preferred embodiment of the invention, a system for objective assessment of learning outcomes, comprising a data repository operating on a network-connected server and comprising at least a hierarchical arrangement of a plurality of learning goals the attainment of which is measurable quantitatively, a plurality of data consistency rules, and a plurality of learning outcome assessment forms, a report generator coupled to the data repository, an analysis engine coupled to the data repository, a rules engine coupled to the data repository, and an application server adapted to receive application-specific requests from a plurality of client applications and coupled to the data repository, is disclosed. According to the embodiment, the application server is further adapted to provide an administrative interface for viewing, editing, or deleting a plurality of learning goals and expectations and relationships between them, learning assessment tools, learning outcome reports, and learning indexes; the rules engine performs a plurality of consistency checks to ensure alignment between and among learning goals, learning assessment tools, learning outcomes, and learning indexes; and the application server receives learning assessment data from a plurality of learning assessors, the report generator generates and distributes learning outcome reports based at least in part on the learning assessment data, and the analysis engine performs preconfigured analyses of learning assessment data to generate a plurality of learning indexes.

According to another embodiment of the invention, the application server is further adapted to provide a learning assessor interface that receives requests for learning assessment tools from learning assessors, sends requested learning assessment tools to requester in the form of a data object, and receives learning assessment data from the requester during or following an assessment of a learning outcome by the learning assessor. In another embodiment, at least a portion of a learning assessment is performed automatically by the analysis engine and results of such automated analyses are included in the data object comprising the learning assessment tools. In a further embodiment, the application server interacts with users via a web server. In some embodiments, the application server interacts with users over a wireless telecommunications network.

According to a further embodiment of the invention, the learning indexes comprise quantitative analytical measures of achieved learning and missed learning per units of learning goals and expectations. In yet a further embodiment, learning indexes are generated for a plurality of individual learners. In another embodiment, learning indexes are generated for a plurality of aggregates of individual learners, assembled based on membership of individual learners in one or more learning units, zones, or levels. In another embodiment, the learning indexes are used to generate grade reports with feedback for learners. In another embodiment, the report generator generates and distributes reports based at least in part on the aggregated learning indexes, the reports identifying areas of achieved and missed learning relative to established learning goals and expectations. In yet another embodiment, the analysis engine performs analysis of a plurality of learning indexes or learning outcome reports, or both, pertaining to a learner and prepares thereby and distributes a learning improvement plan tailored to the learner. In another embodiment, the analysis engine automatically analyzes progress of the learning improvement plan and, based at least on comparing learning outcome assessments from before and from after implementation of the learning improvement plan, adjusts the learning improvement plan or prepares and distributes a new learning improvement plan.

According to another preferred embodiment of the invention, a method for objective assessment of learning outcomes is disclosed, the method comprising the steps of: (a) providing an administrative interface via an application server to allow users to specify a plurality of learning goals and expectations; (b) decomposing at least a portion of the learning goals and expectations into achievable and measurable analytics units; (c) organizing the learning goals and expectations into a hierarchy; (d) automatically performing consistency checks to ensure alignment of learning goals and expectations along the hierarchy; (e) providing a plurality of learning assessment tools to a learning assessor in one of online, mobile application, or thick client application formats; (f) receiving learning outcome assessment data at the level of individual learning outcomes from the learning assessor; (g) calculating learning outcomes as learning indexes at the level of an individual output; and (h) preparing and distributing a plurality of learning outcome reports for the individual learner.

According to another embodiment, the method further comprises the steps of: (i) aggregating a plurality of learning indexes calculated at the level of individual learners into a plurality of learning indexes at multiple levels of units, zones, levels, and the like; and (j) preparing and distributing a plurality of learning outcome reports based on the plurality of aggregated learning indexes. According to another embodiment, the method further comprises the steps of: (k) preparing and distributing a learning improvement plans to enable a specific learner to either overcome weaknesses indicated by missed learning, or build on strengths indicated by achieved learning, or both; (l) automatically monitoring progress of the learning improvement plan; and (m) based at least on comparing learning outcome assessments from before and from after implementation of the learning improvement plan, adjusting the learning improvement plan or preparing and distributing a new learning improvement plan.

According to a further embodiment, in step (e) at least a portion of a planned learning assessment is performed automatically and its results delivered with the an applicable learning assessment tool. In another embodiment, at least some learning assessments are completed automatically, and wherein in step (e) the automatically completed learning assessments are delivered as learning assessment tools to allow learning assessors to review and comment on the automatically generated learning assessment.

### BRIEF DESCRIPTION OF THE DRAWING FIGURES

The accompanying drawings illustrate several embodiments of the invention and, together with the description, serve to explain the principles of the invention according to the embodiments. One skilled in the art will recognize that the particular embodiments illustrated in the drawings are merely exemplary, and are not intended to limit the scope of the present invention.

FIG. 1 is a block diagram illustrating an exemplary hardware architecture of a computing device used in an embodiment of the invention.

FIG. 2 is a block diagram illustrating an exemplary logical architecture for a client device, according to an embodiment of the invention.

FIG. 3 is a block diagram showing an exemplary architectural arrangement of clients, servers, and external services, according to an embodiment of the invention.

FIG. 4 is a block diagram providing a conceptual of a high-level process according to an embodiment of the invention.

FIG. 5 is a block diagram a high-level process flow diagram showing a series of major functional steps carried out according to a preferred embodiment of the invention.

FIG. 6 is a system diagram of an exemplary architecture of a preferred embodiment of the invention.

FIG. 7 is a process flow diagram illustrating a method of establishing and using learning goals, according to a preferred embodiment of the invention.

FIG. 8 is a process flow diagram illustrating a method of establishing and using learning expectations, according to a preferred embodiment of the invention.

FIG. 9 is a process flow diagram illustrating an objective learning assessment method, according to a preferred embodiment of the invention.

FIG. 10 is a process flow diagram illustrating a method of objectively assessing learning outcomes, according to a preferred embodiment of the invention.

FIG. 11 is a process flow diagram illustrating a method of computing learning indexes, according to a preferred embodiment of the invention.

FIG. 12 is a process flow diagram illustrating a learning outcome reporting method, according to a preferred embodiment of the invention.

FIG. 13 is a process flow diagram illustrating a method of computing aggregate learning indexes, according to a preferred embodiment of the invention.

FIG. 14 is a process flow diagram illustrating an objective learning performance reporting method, according to a preferred embodiment of the invention.

FIG. 15 is a process flow diagram illustrating a learning improvements reporting method, according to a preferred embodiment of the invention.

FIG. 16 is a process flow diagram illustrating a learning improvements implementation method, according to a preferred embodiment of the invention.

FIG. 17 is a diagram of an exemplary online assignment grading tool, according to a preferred embodiment of the invention.

FIG. 18 is a diagram of an online course grading tool, according to a preferred embodiment of the invention.

FIG. 19 is a diagram of an online tool for managing learning expectations, according to a preferred embodiment of the invention.

### DETAILED DESCRIPTION

The inventor has conceived, and reduced to practice, a system and various methods for objective assessment of learning outcomes that address the shortcomings of the prior art that were discussed in the background section.

One or more different inventions may be described in the present application. Further, for one or more of the inventions described herein, numerous alternative embodiments may be described; it should be understood that these are presented for illustrative purposes only. The described embodiments are not intended to be limiting in any sense. One or more of the inventions may be widely applicable to numerous embodiments, as is readily apparent from the disclosure. In general, embodiments are described in sufficient detail to enable those skilled in the art to practice one or more of the inventions, and it is to be understood that other embodiments may be utilized and that structural, logical, software, electrical and other changes may be made without departing from the scope of the particular inventions. Accordingly, those skilled in the art will recognize that one or more of the inventions may be practiced with various modifications and alterations. Particular features of one or more of the inventions may be described with reference to one or more particular embodiments or FIGS. that form a part of the present disclosure, and in which are shown, by way of illustration, specific embodiments of one or more of the inventions. It should be understood, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Examples are for illustration purposes and are not limiting.

Devices that are in communication with each other need not be in continuous communication with each other, unless expressly specified otherwise. In addition, devices that are in communication with each other may communicate directly or indirectly through one or more intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described, it will be readily apparent that more than one device or article may be used in place of a single device or article. Similarly, where more than one device or article is described, it will be readily apparent that a single device or article may be used in place of the more than one device or article.

As used herein, numerical values may use any of a plurality of formats, to include whole numbers, decimal numbers, weights, percentages, ranges, formulas, algorithms, grand totals, partial totals, ideal or maximum achievable etc., or any combination thereof.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be noted that particular embodiments include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Definitions

“Learning”, as used herein, means a process of acquiring knowledge and skills. Learning can happen in such environments as education entities, such as schools, colleges, universities, etc., training entities, at home schooling, on line or in brick-and-mortar institutions, and the like, although learning is not limited to these environments, and may be facilitated by one or more teaching agents or establishments, or may be self-directed.

As used herein, “stakeholders” means stakeholders of learning, including but not limited to learners (such as students, trainees, and the like), learners, trainees, learning agents (such as faculty, professors, instructors, teachers, trainers, and the like), learning agencies (such as colleges, schools, kindergartens, universities, technical schools, vocational schools, and the like), administration (such as deans, staff, leadership and staff of learning agencies), accreditation agencies for all schools, colleges, boards, professional schools, Department of Education, boards, state and federal related agencies, political entities with interest in learning, all constituencies with an interest in education or learning, parents of learners, families of learners, communities, employers, recruiters, alumni, publishers of learning materials, etc.

As used herein, “learners” are those who seek to acquire knowledge or skills through learning; learners may be individuals such as students, teams of students, groups of individuals such as classes, courses, sections, modules, grades, college, school, cohorts, etc. A learner is an individual but he/she may also be part of a group that may be multileveled, such as members of a class, college, etc.

As used herein, “learning agents” are individuals who impart learning to others, including but not limited to teachers, educators, faculty, lecturers, trainers, instructors, employees in learning agencies, such as deans, provosts, staff, administrators, etc.

As used herein, “learning agencies” are institutions engaged in imparting learning, or organizations comprised of learning agents and organized at least substantially for the purpose of assisting individuals in acquiring knowledge or skills. Units of learning range from the level where the actual learning takes place (a lesson or class) to an institution of learning for example.

As used herein, “accreditation organizations” analyze and assess performance of learning agencies, such as schools, colleges, universities, etc., in order to determine whether such agencies are qualified to carry on learning activities, for example by determining whether an agency should be authorized to grant degrees. Accreditation organizations may accredit learning agencies to provide them legal or other authority to function as learning agencies.

As used herein, “configurations” comprise one or more units, levels, zones, spans, individuals, groups, agencies, agents, etc., being used for calculations of indexes of learning achieved and missed (in terms of learning goals), for reporting, or for purposes such as generating learning improvement plans, learning progress reports, benchmarking reports, interpretations of learning, learning feedback loops, and the like.

As used herein, “units of learning” refers to entities within which learning takes place, and may comprise one or more of a class, a module, a lesson, a course, and the like (no limitation to these specific examples should be inferred).

As used herein, “levels of learning” are in general descriptive of a degree of advancement of subject matter to which learners are exposed within a specific context, and may for example comprise grades, years, year in a learning program, seniority designations such as sophomore, junior, senior, and so forth.

As used herein, “learning inputs” consist of items appropriate for imparting knowledge to a plurality of learners, and may comprise for example instruction, instruction methodologies, materials, manuals, textbooks, presentations, video, on line or in class, and so forth.

As used herein, “learning output” (or “outcomes”) may for example comprise items that provide evidence of learners' having achieved one or more learning goals, such as papers, essays, tests, exams, presentations, etc. Learning assignments are examples that are designed to show learning by learners, result in learning outputs. Learning outputs or learning outcomes may be reviewed and assessed (what is commonly referred to as “grading”) by learning assessors or agents qualified to do so, including but not limited to educators, faculty, graders, etc. Individual learning outputs represent output of individual learners but also of groups of learners (in case of team projects). Assessments are made first at the level of individual learning outputs. Learning outcomes and performance define consequences of the processes of learning and education. Achieved (acquired) learning shows what learners learned in relation to planned learning goals; missed learning shows gaps or missed learning in relation to planned learning goals. Learning indexes are numeric measures of leaning that quantify learning outcomes (achieved and or missed learning) in all configurations.

As used herein, “achieved learning” or “acquired learning” means that which one or more learners learned in relation to a set of planned learning goals; “missed learning” conversely means gaps or missed learning in relation to planned learning goals. “Learning indexes” are numeric measures of learning that quantify learning outcomes (achieved and or missed learning) in all configurations. Learning indexes are first calculated at the level individual of the learning output unit. They can be calculated at all configurations afterwards by “rolling up” or aggregating learning index data starting with raw data at the level of learning outputs and then working up one or more hierarchies, using weighting factors or other formulae that define how aggregation is to be carried out.

As used herein, “conventional standards” are commonly accepted or understood norms or standards such as grades or qualifications that are used to measure learning. Surveys may also be administered to learners in order to measure learning (they are asked questions related to their having learned, etc.). Numerical values may be (and usually are) associated with conventions (for example, an A has a range of points, etc.)

As used herein, “assessment records”, or “rubrics”, or “templates”, mean “a standard of performance for a defined population”, particularly as it is applied against learning goals. Rubrics etc. may comprise, for example, one or more items such as required ID information, goal metrics or analytics or criteria dimensions on which performance is rated, definitions and examples that illustrate the attribute(s) being measured, and a rating scale criteria item, numerical achievable values in various formats such as percentages, absolute numbers, etc, areas where assessors can select achieved learning items, make notes. Dimensions are generally referred to as criteria, the rating scale as levels, and definitions as descriptors. Rubrics or templates typically reflect learning goals metrics for their specific level such as for example the learning output level. They may also reflect learning expectations metrics.

As used herein, “ideal” or “total achievables” refer to maximum values that could be achieved per selected unit such as goals, categories, subunits, and the like.

As used herein, “learning goals” represent desired endpoints of learning processes at one or more levels. Learning goals may be defined for various levels or units of learning, such as for example by establishing learning goals for institutions, colleges, courses, modules or specific lessons, or output or outcome levels, such as learning goals categories, units, subunits, skills, and so forth. Learning goals represent what learning is planned and should take place in order to fulfill the mission of learning agencies, agents, accreditors, stakeholders of learning, recruiters, employers, communities, etc. Learning goals may be hierarchical in the sense that they are set at various levels such as degrees, courses, modules, lessons, sessions, etc. In this sense, units of learning may also be hierarchical. They may range from, for example, institutions, colleges, degrees, courses, classes, units of learning delivery, learning output, etc. the unit of learning delivery, etc. Goals are ranked, are subdivided into entities such as goal categories, subcategories, units, subunits, assigned weights, designated to corresponding levels and units (configurations) down to the output level. Learning goals are communicated to stakeholders.

As used herein, “learning goal card” (or template) means a visual and generally interactive display that reflects intended goal analytics, whereby learning goals are assigned to various specific levels of learning output, through categories or subunits or the like, and assigned numeric values, criteria of meeting them such as items, means, scenarios, or commentaries per levels of achieved learning or missed learning (for example, 70% breadth or general knowledge, 60% of analytical skills, 50% problem solving, 10% communication skills, and so forth).

As used herein, “learning expectations” are discrete and specific target behaviors to be demonstrated by a learner. Learners are expected to acquire elements of learning and achieve learning goals. Learning expectations can be hierarchical. One or more learning expectations may be designated as elements to be achieved en route to achieving a higher-level learning goal. Learning expectations can be hierarchical and subdivided into levels, down to the level of learning output. They are communicated to stakeholders such as learners. Learning expectations are consistent with learning goals.

As used herein, “learning expectations cards” means a visual and typically interactive display that reflects intended learning expectations analytics at specific levels at the learning output level, such as categories, subunits, numerical values, criteria such as items, scenarios, and commentaries per levels of achieved learning and or missed learning (for example, 70% breadth or general knowledge, 60% of analytical skills, 50% problem solving, 10% communication skills, etc.).

As used herein, an “assessor” is a learning stakeholder (for example, a faculty member, a grader, a teaching assistant, a teacher, an instructor, or the like) or an automated system (such as an automated grading system), or a combination of the two, that is responsible for assessing (grading) one or more learning outcomes. Many examples herein use terms such as “faculty assessor”; these are merely exemplary and other examples are possible as well, according to the invention, and in general the term “assessor” should be understood as defined here.

As used herein, “learning spans” are lengths of time over which one or more learning goals or learning expectations may be expected to be achieved or completed, and may comprise classes, years, degree time, specific periods of time, and so forth. “Historical learning” refers to learning progress during specific times.

As used herein, “learning zones” are geographical areas within which learning may be conducted in pursuit of one or more learning goals or expectations, such as for example zones, locations, sectors, chapters, regions, countries, continents, etc.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be disclosed herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, and the like), a consumer electronic device, a music player, or any other suitable electronic device, router, switch, or the like, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or the like).

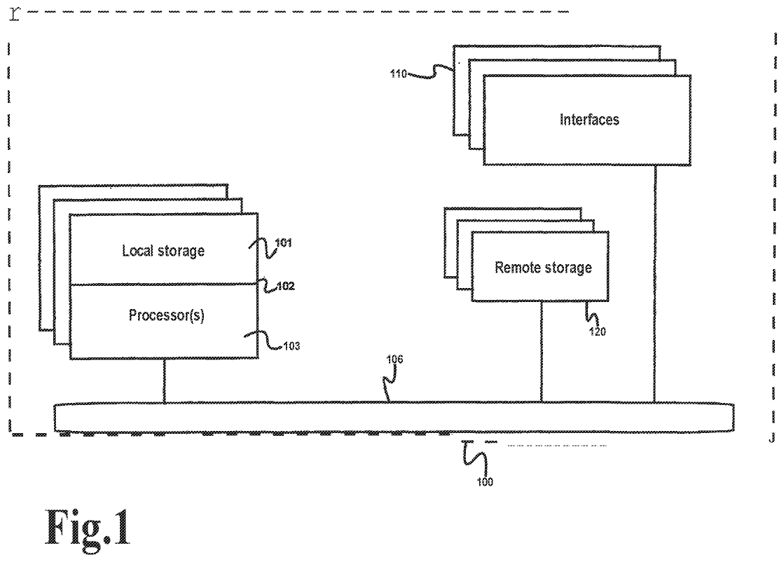

Referring now to FIG. 1, there is shown a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software- or hardware-based instructions according to one or more programs stored in memory. Computing device 100 may be adapted to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more busses 106 (such as a peripheral component interconnect (PCI) bus). When acting under the control of appropriate software or firmware, CPU 102 may be responsible for implementing specific functions associated with the functions of a specifically configured computing device or machine. For example, in at least one embodiment, a computing device 100 may be configured or designed to function as a server system utilizing CPU 102, local memory 101 and/or remote memory 120, and interface(s) 110. In at least one embodiment, CPU 102 may be caused to perform one or more of the different types of functions and/or operations under the control of software modules or components, which for example, may include an operating system and any appropriate applications software, drivers, and the like.

CPU 102 may include one or more processors 103 such as, for example, a processor from one of the Intel, ARM, Qualcomm, and AMD families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random access memory (RAM) and/or read-only memory (ROM), including for example one or more levels of cached memory) may also form part of CPU 102. However, there are many different ways in which memory may be coupled to system 100. Memory 101 may be used for a variety of purposes such as, for example, caching and/or storing data, programming instructions, and the like.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 110 are provided as network interface cards (NICs). Generally, NICs control the sending and receiving of data packets over a computer network; other types of interfaces 110 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, Firewire™, PCI, parallel, radio frequency (RF), Bluetooth™, near-field communications (e.g., using near-field magnetics), 802.11 (WiFi), frame relay, TCP/IP, ISDN, fast Ethernet interfaces, Gigabit Ethernet interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 110 may include ports appropriate for communication with appropriate media. In some cases, they may also include an independent processor and, in some in stances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, a single processor 103 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 120 and local memory 101) configured to store data, program instructions for the general-purpose network operations, or other information relating to the functionality of the embodiments described herein (or any combinations of the above). Program instructions may control execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory, solid state drives, memristor memory, random access memory (RAM), and the like.

Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

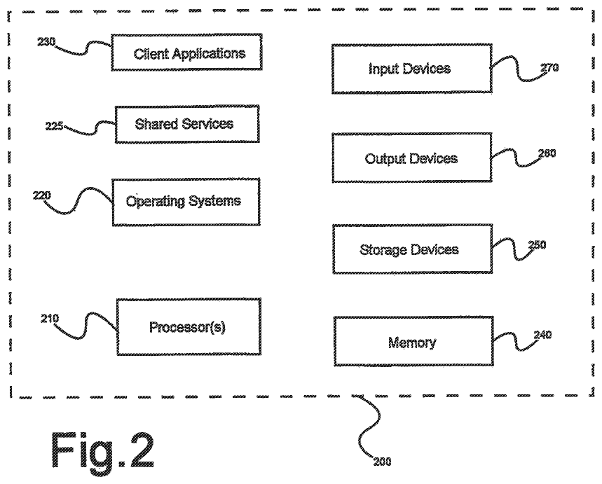

In some embodiments, systems according to the present invention may be implemented on a standalone computing system. Referring now to FIG. 2, there is shown a block diagram depicting a typical exemplary architecture of one or more embodiments or components thereof on a standalone computing system. Computing device 200 includes processors 210 that may run software that carry out one or more functions or applications of embodiments of the invention, such as for example a client application 230. Processors 210 may carry out computing instructions under control of an operating system 220 such as, for example, a version of Microsoft's Windows™ operating system, Apple's Mac OS/X or iOS operating systems, some variety of the Linux operating system, Google's Android™ operating system, or the like. In many cases, one or more shared services 225 may be operable in system 200, and may be useful for providing common services to client applications 230. Services 225 may for example be Windows™ services, user-space common services in a Linux environment, or any other type of common service architecture used with operating system 210. Input devices 270 may be of any type suitable for receiving user input, including for example a keyboard, touchscreen, microphone (for example, for voice input), mouse, touchpad, trackball, or any combination thereof. Output devices 260 may be of any type suitable for providing output to one or more users, whether remote or local to system 200, and may include for example one or more screens for visual output, speakers, printers, or any combination thereof. Memory 240 may be random-access memory having any structure and architecture known in the art, for use by processors 210, for example to run software. Storage devices 250 may be any magnetic, optical, mechanical, memristor, or electrical storage device for storage of data in digital form. Examples of storage devices 250 include flash memory, magnetic hard drive, CD-ROM, and/or the like.

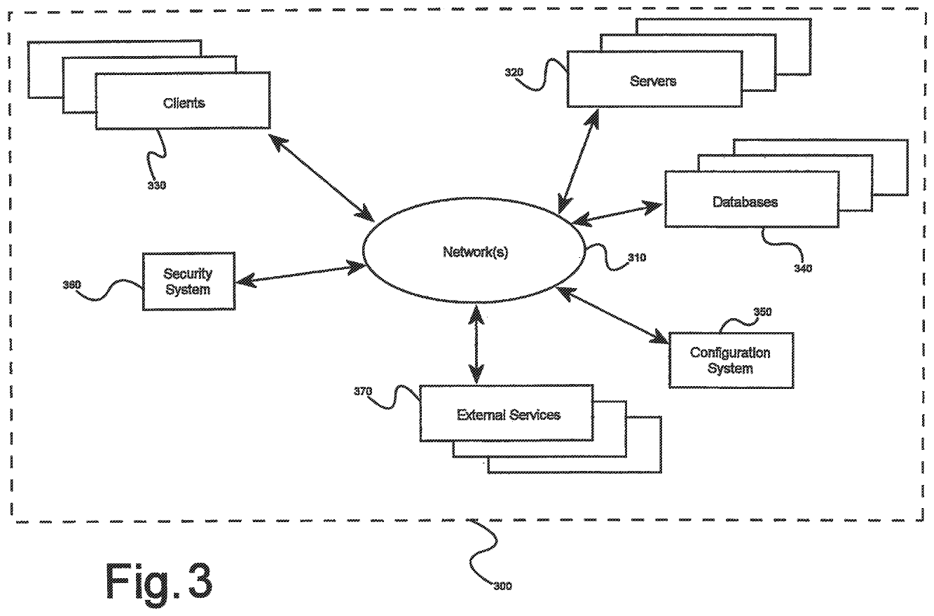

In some embodiments, systems of the present invention may be implemented on a distributed computing network, such as one having any number of clients and/or servers. Referring now to FIG. 3, there is shown a block diagram depicting an exemplary architecture for implementing at least a portion of a system according to an embodiment of the invention on a distributed computing network. According to the embodiment, any number of clients 330 may be provided. Each client 330 may run software for implementing client-side portions of the present invention; clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments any of the Internet, a wide area network, a mobile telephony network, a wireless network (such as WiFi, Wimax, and so forth), or a local area network (or indeed any network topology known in the art; the invention does not prefer any one network topology over any other). Networks 310 may be implemented using any known network protocols, including for example wired and/or wireless protocols.

In addition, in some embodiments, servers 320 may call external services 370 when needed to obtain additional information, or to refer to additional data concerning a particular call. Communications with external services 370 may take place, for example, via one or more networks 310. In various embodiments, external services 370 may comprise web-enabled services or functionality related to or installed on the hardware device itself. For example, in an embodiment where client applications 230 are implemented on a smartphone or other electronic device, client applications 230 may obtain information stored in a server system 320 in the cloud or on an external service 370 deployed on one or more of a particular enterprise's or user's premises.

In some embodiments of the invention, clients 330 or servers 320 (or both) may make use of one or more specialized services or appliances that may be deployed locally or remotely across one or more networks 310. For example, one or more databases 340 may be used or referred to by one or more embodiments of the invention. It should be understood by one having ordinary skill in the art that databases 340 may be arranged in a wide variety of architectures and using a wide variety of data access and manipulation means. For example, in various embodiments one or more databases 340 may comprise a relational database system using a structured query language (SQL), while others may comprise an alternative data storage technology such as those referred to in the art as “NoSQL” (for example, Hadoop, MapReduce, BigTable, and so forth). In some embodiments variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 360 and configuration systems 350. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 360 or configuration 350 system or approach is specifically required by the description of any specific embodiment.

In various embodiments, functionality for implementing systems or methods of the present invention may be distributed among any number of client and/or server components. For example, various software modules may be implemented for performing various functions in connection with the present invention, and such modules can be variously implemented to run on server and/or client components.

### Conceptual Architecture

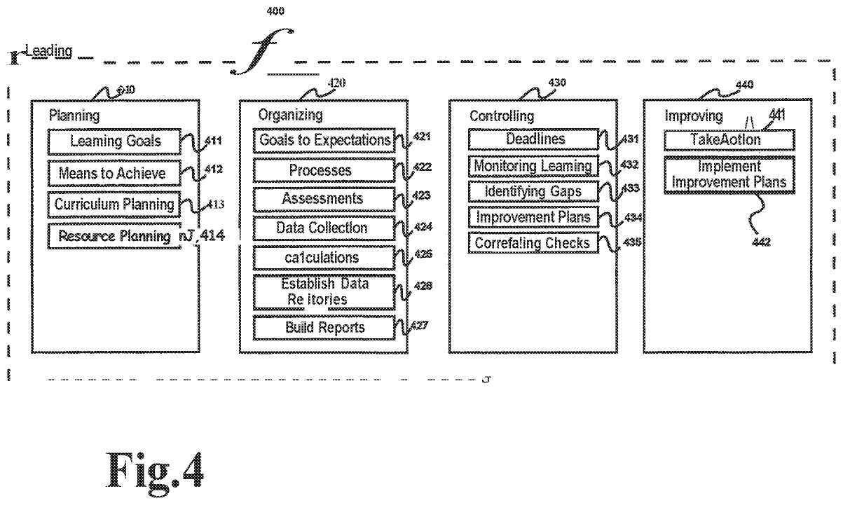

FIG. 4 provides a high-level diagram of a preferred embodiment of the invention, which will be useful for discussing aspects of the invention and improvements inherent in the invention over systems known in the art. According to the embodiment, an online system is provided to enable an enhanced learning leadership process 400 comprising four high-level subprocesses that together enable effective learning to take place at various educational or training levels and various learning agencies: planning 410, organizing 420, controlling 430, and improving 440. According to the embodiment, planning 410 further comprises establishing learning goals 411 at various levels of a hierarchy, placing some or all learning goals within one or more learning goal categories, specifying one or more weights for learning goals and categories of learning goals, specifying configurations for learning indexes and configurations and types of reports of achieved and missed learning, based on learning goals and learning expectations, providing one or more means to achieve learning goals 412, performing curriculum planning 413 to ensure adequate instructional materials are in place to support learning, and performing resource planning 414 to ensure that adequate levels of learning agent resources are maintained to support effective learning.

According to the embodiment, organizing 420 comprises a series of online processes or systems that collectively facilitate achieving an effective organization of resources (learning agents, learning materials, administrative infrastructure, objective learning assessment tools, and the like) based on plans established in planning process 410. In order to translate learning goals, which may be abstract or high-level, into concrete, measurable deliverables useful to learners, detailed learning expectations 421 may be established at various levels of a hierarchy based on learning goals, with one or more weights optionally being specified for learning expectations. For example, various learning goals for an English literature class might address a need for developing breadth of knowledge of the subject (e.g., demonstrate familiarity with the important periods in the development of English poetry, of English novels, and of English essays); depth of knowledge (e.g., demonstrate familiarity with the leading writers and ideas of early 18th century political satirists); and particular high-level skills (e.g., develop proficiency in analytical reasoning and in-depth analysis of literary works, or improve analytical writing skills). These goals could then be used to generate more specific, detailed learning expectation and/or goals, such as being able to name three important Elizabethan dramatists and representative works of each, or “perform a critical written analysis of a specific major work of poetry”, and so forth. Both goals and expectations will generally be hierarchical. For example, within the learning expectation “perform a critical analysis . . . ”, there would typically be several subordinate learning expectations, such as “identify the metric structure of the poem” or “identify three main themes of the poem”; these may be subdivided themselves, for instance by having an expectation that a learner identifies a transition point from one metric style to another within the poem, and discusses reasons for the transition or effects achieved by the transition.

Additional activities undertaken during organizing 420 may include designing one or more learning processes 422, designing or creating various forms, records, and/or rubrics or other tools for performing assessments 423 of learning, designing one or more data repositories and specifying data fields including identifying fields for various hierarchy levels, organizations, zones, and the like, establishing routines for and carrying out data collection 424 regarding various aspects of the learning environment (for example, organizational structures within a university, course catalogs, learner rosters, faculty rosters, previous learner learning histories at the same or other institutions, regulatory requirements such as required tests and required proficiency demonstrations, and so forth), performing calculations 425 required to implement a consistent, hierarchical objective learning assessment system, building or establishing data repositories 426 that will be available to appropriate users (such as learners, learning agents, administrators, and so forth), and building a plurality of reports 427 or report templates that may be used by administrators, regulators, and others to assess and analyze the performance of learning processes and learning organizations.

Once organizational steps 420 have been taken and an online learning environment is fully established, the system may be used according to the embodiment for controlling 430 learning delivery or performance. Controlling activities 430 may comprise, for example, carrying out assessments or evaluations of learning output, using assessment forms, records, rubrics, and the like, calculating individual output level learning indexes, calculating aggregate indexes of learning, establishing deadlines 431 (for example, by ensuring that early material is covered quickly enough to enable all required materials to be covered in the time allotted for a specific course), monitoring learning 432 to identify issues as they occur in order to support continuous improvement, identifying gaps in learning 433 based on monitoring results, developing improvement plans 434 based on identified gaps, generating reports of achieved and missed learning at all levels and units, devising improvement plans based on results of assessments and/or data in reports, and performing consistency checks 435 to ensure that goals and expectations are in alignment, that hierarchies are internally consistent, and numerical consistency is maintained (for instance, percentile scores add to 100%).

As learning progresses, lessons are typically learned by learning organizations based on what worked, and what didn't, during learning delivery. Accordingly, in a preferred embodiment of the invention an automated process for improving 440 learning delivery is provided, comprising the steps of taking actions 441 to address problems identified, and implementing improvement plans 443. As should be clear, FIG. 4 provides a high-level, conceptual overview of what is performed by various embodiments of the invention; these actions or processes will be described in much more detail throughout this document.

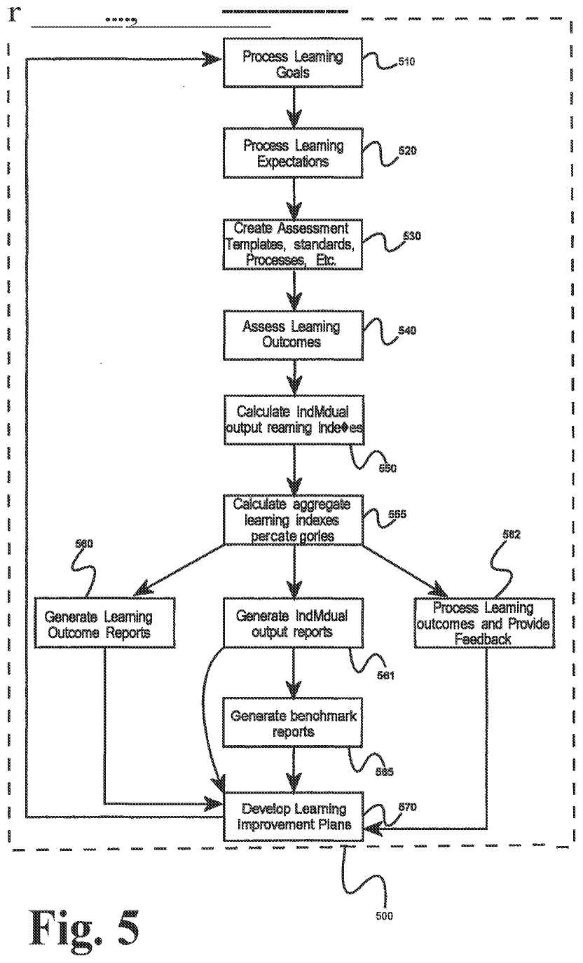

FIG. 5 is a somewhat more granular overview of a method for conducting objective learning assessment, according to a preferred embodiment of the invention. According to the embodiment, one or more learning agents and agencies, learners, administrators, other stakeholders, and the like determine overall learning ideals in step 510, such as overarching learning goals and may rank them in order of importance. Processes of making goals concrete and measurable, and hence achievable, follow. Learning goals are ranked, assigned numerical values such as weights, decomposed into analytical units (such as categories, subcategories, units sub units within, etc) and assigned per levels, units of learning, such as degree, courses, years, sections, classes, modules, learning delivery, learning output, etc. Typically, various learning goals and their components, such as subgoals, are assigned one or more weights that are used in turn when assessing overall learning achievement (since some goals might be more or less important than others). Means and requirements to achieve learning goals at levels and units of learning may be developed, to include among others learning materials, assignments, etc. Goal metrics or analytics are developed, including goal units, weights, numerical values, criteria, etc. Categories of learning goals are selected, including, for example, breadth, depth, analytical, communication, practice, etc. Goals can be divided even further into subcategories subunits, etc. (for example, within analytical skills there may be applying concepts, discussing, comparing and contrasting, etc., within communication skills there may be writing, public speech, business writing, technical writing etc). Goal units and subunits are assigned weights. Highest (ideal) achievable numerical values per each goal unit category subunit are established. Criteria show requirements for learners to demonstrate learning. Criteria include items and scenarios of learning, numerical values (such as percentages, weights, whole numbers, etc.). Scenarios of learning (for example, “identify 3 theories 100%, 2 theories 75%, translating into a B+ per category”), of meeting categories of learning goals are developed (for example, only 2 theories identified, meaning 70% of breadth/general knowledge), which can be expressed in various units or ways (for example, “all or nothing”, “% of all”, X % of analytical, and so forth). Numeric values are assigned to goals at levels and units of learning, to goal categories, and scenarios of learning. Numeric values may include any of ideal totals, absolute values, and percentages. Weights of goal category may vary, for example 10% for “research”, 60% for “breadth”, and so forth). Commentaries (such as for example, “You applied 3 theories to facts, showing good analytical skills”, or “You applied only 2 and need more focus on analysis”) may be developed per levels and units of learning, per categories, all goal units/subunits, and scenarios of learning. Learning goals and goals subdivision units are assigned one or more weights to facilitate their combination into higher-level aggregates, and to account for varying relative importance of different learning goals.

In step 520, one or more learning agents and agencies, learners, administrators, and faculty establish learning expectations, based upon learning ideal goals defined in step 510; learning expectations may be established for specific levels, units, categories of learning goals. Learning goals may be ranked, and numeric values such as weights may be assigned for expectations at levels, units, learning delivery, learning output, categories of learning, established means of learning, requirements of learning expectations at levels, units of learning, including delivery and output may be developed, and units, or categories of learning. Expectations and numeric values can be developed at the level of specific learning scenarios. Processes of establishing learning expectations may use learning goals from step 510, or in some embodiments may be generated independently and checked against goals to ensure consistency. Learning expectations may be decomposed into analytical units. Explanations of learning expectations at all levels and across all options, such as metrics and analytics, may be developed (that is, explanations of expectations' explicit meanings, values, criteria, learners' requirements of learning goals at levels, units, categories, subcategories, scenarios of learning). Explanations of ratings of learning outcomes (such as grades) and of ranges of met learning may also be developed. As a detailed example of this process, in an embodiment general learning expectations to meet general learning goals (ideals) are first established. Then, learning expectations per learning levels, units, categories, scenarios are determined. Highest (ideal) achievable numerical values per each expectation unit category subunit may be established. Then, learning expectations metrics or analytics, to include numeric values of learning expectations per levels, units, categories, scenarios of learning are assigned. Then, learning expectations criteria to meet expectations, requirements per levels, units of learning, categories, scenarios of learning are created or specified. Then, learning expectations may be enhanced to clearly explain ranges of achievement of learning goals and what various sub ranges signify in terms of learning achievement, and explanations per ranges and per ratings (such as grades) may be provided. Finally, in some cases additional directions pertaining to how to improve learning based on achieving or not achieving one or more defined learning expectations may be provided. As in the case of learning goals, learning expectations are typically (but not necessarily) assigned one or more weights to facilitate their combination into higher-level aggregates, and to account for varying relative importance of different learning expectations.

In step 530, various means of objectively assessing learning achievement or performance, by comparison of actual versus intended results in terms of defined learning goals and learning expectations, may be provided. Such means may comprise, but are not limited to, assessment templates, rubrics, records, forms to be used by learning agents when assessing one or more individual learning outputs (e.g., exams, quizzes, assignments, papers, and so forth), assessment standards (such as standard grading practices), and assessment processes. Assessment forms show ID information, goals metrics, and or expectations metrics at required levels and units, to include output levels, among others.

Then in step 540, learning agents (possibly using one or more of the outputs of step 530, to include assessment forms, rubrics, templates, etc.) assess learning outcomes at the level of learning output. It is important to have each learning output assessed. At this stage, an output may be the product of one or more learners (for example, an output may be a team project, a result for one student on one quiz, a result for many students on one quiz, or a result for all students in several sections of a course on all of their or coursework to date). Learning assessors may review learning outputs and, using assessment forms, may enter (or mark or underline or note or pencil on screen) corresponding to achieved learning items, scenarios, criteria, units subunits in goal categories and units, such as numerical values or any other form.

In step 550, learning indexes of achieved and missed learning are calculated at the individual output level. An example of a learning index is an overall grade for a class, which would be generated by some mathematical combination of particular grades achieved on specific assignments, tests, and projects. At first learning indexes may be computed per output per goal category/unit/subunit (for example learning output ID of course, module, learner, goal category of breadth (for example, measured as a percentage or a numeric value or a conventional grade, or any combination of these or other measurement types). Learning indexes at the output level per learner (and or group of learners if the output is team based) are maintained in repositories 640, along with ID information, as well as assignments submitted by learners, as well as weights of goals, goal categories, and so forth.

Once all these individual output learning indexes per established learning goals categories are calculated by the system (after one or more assessors selects values and enters them in the system), the system performs calculations based on formulae to compound, aggregate, weight learning indexes at all configurations, showing achieved learning or and missed learning at those configurations (or adds up and weighs learning indexes at other configurations, for example analytical skills for Module x for all learners). Calculations may readily obtain learning indexes of all learning goal categories as well as overall ones per unit (for example, per module learner X achieved 70% of overall goals, out of which percentage per category can be derived; ranges or whole numbers can be used). In step 555, one or more objective learning assessment results may be combined into a plurality of learning indexes. An example of a learning index is an overall grade for a class, which would be generated by some mathematical combination of particular grades achieved on specific assignments, tests, and projects. Based on results generated in steps 540, 550, 555, various objective learning assessment output products may be provided, in various embodiments. For example, one or more learning outcome reports may be generated in step 560, for instance to provide information to institutional administrators on learning performance at various levels within an institution, showing learning achieved in comparison with goals. Accreditation agencies may require reports of achieved learning outcomes that were objectively and consistently assessed, at many configurations, in order to allow them to compare reports of achieved learning or missed learning across institutions in a region, which allows them analyze achieved learning and missed learning in relation to learning goals and to make better decisions of accreditation and objective recommendations. In step 561, benchmark reports may be generated to compare one or more levels, zones, or categories against each other to further characterize learning process effectiveness in various ways. For instance, a benchmark report might be used to compare science teachers' success at preparing students for standardized college entrance examinations throughout a school district. Accreditors need benchmark reports. Recruiters identify better-fit potential employees based on acquired skills as met learning goals (Achieved learning versus goals). In step 562, learning outcomes may be processed automatically in order to provide feedback to one or more learning stakeholders. For example, grade and feedback reports might be sent to students, their parents, or both; such reports might comprise not only letter or number grades as expected, but also trend information, comparison information against a student's own or other cohorts, and faculty- or automatically-generated recommendations or qualitative assessments (for example, “student has shown marked improvements and is performing now at a level 10% above her peers; with more attention to detail in problem solving, she could easily achieve much better results next quarter”). Flowcharts can be used to show achieved and missed learning per category per output or in comparison with peers' outputs. Individual output reports of achieved and missed learning can be produced following Step 550 as well. Historical assessments of one learner or groups of learners can be produced.

Individual output reports (or grade reports) can show achieved and missed learning per goal or and expectation category unit subunit, in a quantitative fashion (percentages, grades, numbers, and so forth), and can provide feedback for example in the form of commentaries based on achieved learning per goal categories/units explaining grade and reasons for it, as recommendations for improvement, etc.

Finally, according to the embodiment, in step 570 one or more learning improvement plans may be automatically generated based on the results of the earlier steps. Such improvement plans may be used as a feedback mechanism to any step in the process (feedback for refinement of goal establishment in step 510 is illustrated in FIG. 5 as an example, although feedback to any level may be provided in step 570). It should be apparent to one having ordinary skill in the art that an automated, online system for generating and tracking goals and expectations, providing and using objective learning assessment criteria, assessing learning outcomes based on learning goals and or learning expectations and aggregating the results, and then reporting on and analyzing the results for various purposes and recipients in order to assess and improve learning processes at all levels will enable continuously improvement of learning in a wide range of venues and subjects.

### Detailed Description of Exemplary Embodiments

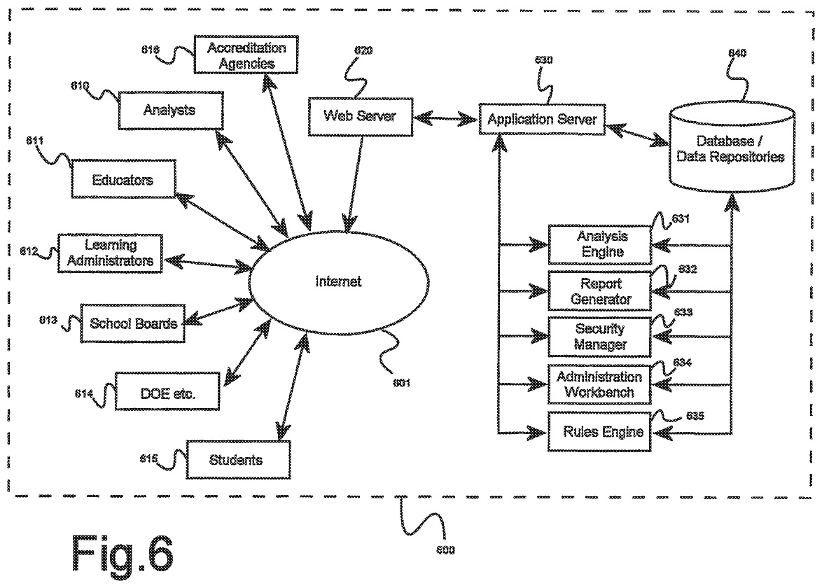

FIG. 6 provides a logical system architecture diagram of a preferred embodiment of the invention, in which an online system 600 for automatically managing and objectively assessing learning processes and outcomes is provided. As discussed above with reference to hardware architecture, many variant architectures may be used without departing from the scope of the invention. For example, only one database 640 (or set of data repositories) is illustrated in FIG. 6. However, this is done for clarity and to avoid clutter; it is well known in the art that database functionality may be provided using many logically equivalent architectures, any of which may be used according to the invention (clustered databases, column-oriented databases, in-memory databases, NoSQL-type databases, flat files, and so forth, whether on one general purpose computer, on a network attached storage appliance, or on many networked computing devices of any type) Similarly, only one web server 620 is shown in FIG. 6, but it should be understood again that this is for simplicity of illustration, and in fact many web servers may be used according to the invention, or alternative online architectures not using a web server at all (for example, a client-server architecture or a mobile application interacting with a mobile network and a variety of application-specific servers).

According to the embodiment, system 600 provides services via Internet 601 or an equivalent network (for example, a mobile network or a private wide area network) to various learning stakeholders. Among these may be analysts 610, educators (learning agents) 611, learning administrators 612, school boards 613, regulators and government agencies 614 such as the United States Department of Education, and learners (learners) 615. These users 610-615 may access one or more services provided by system 600 via a web browser, a mobile or tablet computing device application, or any other suitable communications means. According to an embodiment, services are provided via Internet 601 when web browsers of various users 610-615 connect to web server 620, which serves web pages or their equivalents to users' browsers on request. As is typical in web applications, web server 620 passes through application-specific requests to one or more application servers 630, which in turn generally provide access to and use of data stored in one or more databases 640 or data repositories. It should be recognized that web server 620, application server 630, and database 640 collectively represent a typical web-centric application architecture, but that any logically equivalent architecture may be used without departing from the scope of the invention. The inventor has not invented a novel architecture, but rather an novel system 600 for objectively assessing learning outcomes for a wide range of learning stakeholders, using modern Internet technologies to achieve a level of scale, depth, and analytical sophistication that has not heretofore been possible, thereby mitigating the key problems of subjectivity, bias, and variability among learning outcome assessments in the art (which preclude meaningful comparisons across levels, zones, and subjects, and which acts to at least partially prevent effective use of automation in learning delivery).

According to an embodiment, various specialized functions may be performed by application server 630 or using dedicated software applications running on the same or another computer coupled via a network to application server 630; such specialized application service provider software modules are shown as separate components in FIG. 6 in order to clearly highlight logically distinct functions that may be utilized within system 600, without necessarily implying any particular physical or logical arrangement of the services. Similarly, one or more of these specialized service providers may interact directly with database 640, or may interact with database 640 via application server 630, or both. Such specialized service providers may comprise an analysis engine 631, a report generator 632, a security manager 633, an administration workbench or administration manager 634, and a rules engine 635, although this list is illustrative and not comprehensive. For example, in some embodiments learning goals and learning expectations may be managed by a separate planning server, while in other embodiments those functions may be carried out directly by web server 620 and application server 630 working together using configuration data stored in database 640. Similarly, in some embodiments a separate configuration subsystem may be provided.

Data repository 640 may be used to store and document data pertaining to learning goals and processes related to learning goals, all the way down a hierarchy to specific units of learning delivery and learning outputs, including assigned values and formats, analytical means, feedback, etc. Identification of units of learning delivery and learning outputs may also be stored in database 640 (examples to include but not limit degrees, courses, classes, modules, teaching units, assignments). Identification could contain, for example, institution/college codes/ID, degree, course, etc. in formats including acronyms, numbers, symbols, etc.

Analysis engine 631 is a software component or a hybrid software/hardware component adapted to conduct analyses of large quantities of data obtained from objective learning assessment system 600 or associated exemplary process 500. For example, each step in process 500 typically creates and consumes data, which can be stored in database 640 or equivalent. Examples of data created or consumed by process 500 (or similarly, used within system 600) may comprise one or more of:
Data pertaining to learning goals, including but not limited to: identifying information regarding learners and other users of goals, units of learning (courses, degrees, lessons, modules, assignments, etc.), learning zones (schools, districts, regions, etc.), goals and subgoals, categories and subunits of learning goals, weights, goals metrics, criteria, learning scenarios, numeric values associated with learning goals, subgoals, categories of goals, and scenarios, commentaries or other goal-related textual data, and data pertaining to achievement or missing of learning goals;

Data pertaining to learning expectations, including but not limited to: identifying information regarding learners and other users of expectations, units of learning (courses, degrees, etc.), learning zones (schools, districts, regions, etc.), expectations (potentially arranged in a hierarchical fashion of arbitrary depth), categories of learning expectations, learning scenarios, means intended for achieving learning expectations, numeric values associated with learning expectations, categories and subunits of expectations, weights, expectation metrics, and scenarios, criteria, commentaries or other expectation-related textual data, and data pertaining to achievement or missing of learning expectations;

Data pertaining to objective learning assessments, including but not limited to assessment means for creating learning achievement records, rubrics, templates, or learning assessment records per individual learner per learning output per learning unit, learning achievement records including identifiers (including information identifying learners (such as identifiers, ID, names, code, SSN, other information), institutions (such as colleges, schools, institutions), learning agents (such as instructors, faculty members, trainers), and learning levels and units (such as degrees, classes, sections, subsections, years, training courses, modules, output, and the like), learning goal metrics with identifiable information, and learners' learning outputs with identifiable information. With identifiable information. Learning achievement records (the outputs of objective learning assessments) may merge identifying information, learning goal information, and learning expectations pertaining to one or more levels, units, categories, or scenarios of learning, and may comprise numeric values, explanations, commentaries, or other data types;

Learning indexes per individual learning output (along with ID required from Institution course, module, instructor, learner, and so forth) expressing achieved and missed learning based on learning goals, as percentages, numbers, grades, per each learning goal (and or learning expectation) category, unit, subunit, along with assessment record, or rubric, or template, and output. Learning indexes at the output level for each goal category or unit/subunit provide a basis for further calculations and assessments. Learning goal weights, learning goal category weights per all levels and units, output, delivery, etc. are stored in learning indexes databases 640; and

Data pertaining to proposed learning improvement actions and plans and their outcomes.

Analysis engine 631 may, in some embodiments, operate on data such as those elements just listed to perform one or more of the following exemplary functions:
Calculate learning indexes at the individual output levels;
Calculate one or more learning indexes regarding one of or groups of learners, learning agents, levels, zones, or institutions;
Perform automated educational fraud detection by comparing, for example, a distribution of learning outcomes generated regarding a first set of learners by one learning agent to a similar distribution generated regarding a plurality of second learning agents, in order to detect for example systematic inflation of standardized test scores to satisfy regulatory requirements or to influence economic outcomes for a learning agent;
Identify one or more trends in data, such as temporal patterns, that may be used to predict when one learners or a group or class of learners may be in danger of falling behind in learning achievement;
Compute reports of extent and content of learning based upon learning goal for accreditations, and
Compute complex learning indexes that may for example act as indicators of learner aptitude for a competitive program or outcome such as admission to an elite university.

Report generator 632 may comprise a software module adapted to retrieve data from database 640 in order to create a set of configurable reports suitable for consumption by various learning agents, learners, administrators, and the like, to assess progress of learners or effectiveness of one or more learning processes. It should be appreciated by one having ordinary skill in the art that there many different report generators known and available in the art, any of which may be used according to the invention.

Security manager 633 may enforce a plurality of security policies, such as access rules based on user identities or user memberships in one or more predefined groups (such as administrators, faculty members, learners/learners, and so forth). It should be appreciated by one having ordinary skill in the art that there many different security means known and available in the art, any of which may be used according to the invention.

Administration workbench 634 may be a web-based or dedicated client application used by administrators of system 600 to, for example, establish and monitor security rules, monitor operation of system components to ensure early fault detection, and so forth. It should be appreciated by one having ordinary skill in the art that there many different system administration means known and available in the art, any of which may be used according to the invention.

Rules engine 635 may comprise one or more software modules adapted to execute, on request, one or more rules or rule sets and to trigger further actions in response to such rules as required. For example, frequently herein mention will be made of “consistency checks”, which are checks made automatically to ensure that various data integrity rules and learning policies are enforced. Such consistency checks may commonly be (but need not necessarily be) carried out by rules engine 635. Consistency checks may for example include (but are not limited to) checking that learning goals at all units, levels, and so forth, are internally consistent (are goals at lower units consistent with overall goals; are all items consistent at a goal unit, such as values, means, feedback?). Consistency checks may also be conducted to ensure learning goals are aligned with planned learning inputs (for example, including but not limited to materials, methods of learning/instruction, and so forth), or with means of achieving them by learners (for example, criteria, scenarios, and the like).

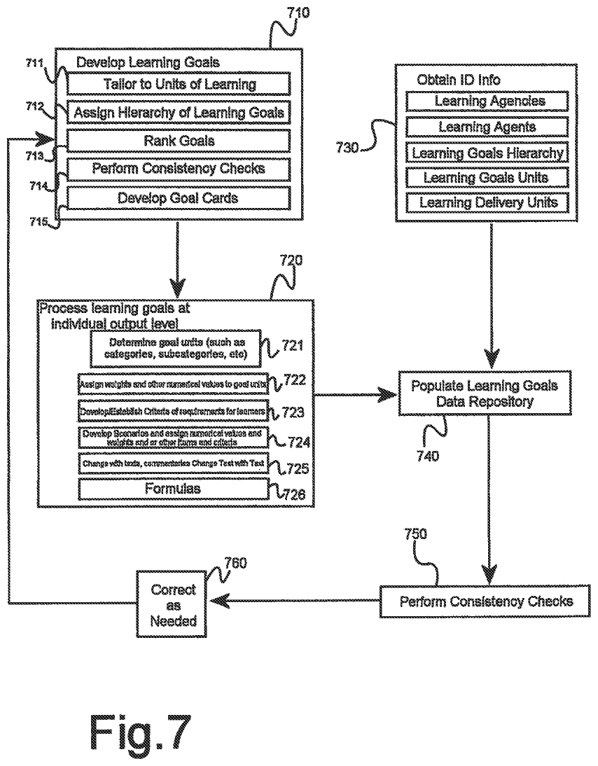

FIG. 7 is a process flow diagram illustrating a method 700 of establishing, processing, and using learning goals, according to a preferred embodiment of the invention. Learning goals may be set at various levels and units of learning, such as at institutional, college, course levels or on a per-module or per-lesson basis. Learning goals represent what learning is planned and should take place in order to fulfill a mission of one or more learning agencies, agents, accreditation entities, stakeholders of learning, recruiters, employers, communities, and so forth. Learning goals may commonly be hierarchical in the sense that they are set at various levels such as degrees, courses, modules, lessons, sessions, although they need not be. In this sense, units of learning may be hierarchical. According to the embodiment, learning agents, agencies, learners, administrators, or other participants determine one or more overall learning goals in high-level step 710. Learning goals are processed to become measurable, doable, concrete, achievable. In general, specific goals may be ranked based on desired order of importance or relevance and assigned weights, and will be tailored to specific units of learning 711 and correspondingly assigned to one or more levels to create a hierarchy of learning goals 712. In some embodiments, participants may rank goals 713 based on a desired order of importance or relevance. In general, according to the embodiment goals are made concrete and measurable, hence making objective learning assessment achievable. Learning goals may decomposed into categories, analytical units assigned per levels or units of learning (such as degree, courses, years, sections, classes, modules, learning output, etc.). Means and requirements to meet learning goals at various levels and units of learning are developed. Goal metrics or analytics are developed. Categories of learning goals and subdivisions of categories may be selected, for example corresponding to desired skills such as analytical, communication, practice, etc. Means and requirements needed to satisfy categories of learning goals may be developed, including for example learning materials, quizzes, tests, and assignments. Learning goals criteria to include scenarios, items, numerical values are developed. One or more scenarios of learning achievement or descriptions of success in meeting categories of learning goals may be developed (for example, “all”, “some % of all”, “none”, “most”, “some”, and so forth). Numeric values are assigned to goals when appropriate, at levels and units of learning, to goal categories, criteria, and scenarios of learning. Numeric values may include totals, absolute values, or percentages. Commentaries and recommendations may be developed per levels and units of learning, per categories and scenarios of learning. One or more consistency checks 714 may be performed to ensure consistency of goals and their quantitative breakdowns at various levels of goal hierarchy. In some embodiments, goal cards, templates, or rubrics are developed in step 715 to enable participants to assess progress toward achieving one or more goals easily, by quantifying achieved or missed learning, particularly in relationship to learning goals or expectations. Goal cards may reflect goal analytics or metrics along with relevant information.

Once goals have been created and optionally assigned to a hierarchy in step 710, in step 720 processing of learning goals at the level of individual output delivery takes place and one or more analytical criteria may be defined that will be used in assessing progress in achieving goals at various levels of a hierarchy. In step 721, goal units and subdivisions such as categories are determined per unit of learning delivery and learning output, in order that later assessments may be carried out in an objective, quantitative manner. In step 722, numerical values may be assigned to goals at various levels in a hierarchy for the same purpose. In step 723, criteria (various means) for achieving goals may be specified, and scenarios of items may be developed (and weights may be assigned to scenarios). Other criteria may be used. For example, one goal may be satisfied by completion of a satisfactory term paper on one of a set of topics related to an overall goal. In another example, an examination score of 80% or better may be specified as a means to demonstrate completion of a goal of “achieve proficiency in working with trigonometric identities”. In some embodiments, in step 724, one or more significance text data elements may be created, configured, or specified. For example, a significance text “This area needs significant improvement” may be specified for situations when certain goals are only met at some predetermined level (say 70%) suitable for “passing” the goal, but not by much. Finally, in some embodiments one or more formulas may be specified in step 725 for use in assessing goal completion. For example, a formula might combine various assignment completion data points, exam and quiz scores, and class participation scores to arrive at a quantitative level that characterizes whether a certain goal is met or not (or to what degree it is met). The method further analyzes each assignment into goal categories units achieved and missed learning. In general, data (such as goals, means, levels, formulas, etc.) created in these and subsequent steps may be stored temporarily in local memory, and is also generally stored in database 640, sometimes within a specific data repository (such as a learning goals data repository) within database 640, although different data storage arrangements are possible according to the invention, as should be clear to one having ordinary skill in the art. Such data, as well as identifying information 730 such as information pertaining to learning agencies 731, learning agents 732, learning goals hierarchies 733, learning goals units 744, and learning delivery units 745, may be sent in step 740 to populate one or more learning goals data repositories. Again, as before, consistency checks may be performed in step 750 to ensure internal data consistency across goal categories, learning levels, and levels of goal hierarchies. When consistency checks fail, corrective steps may be taken in step 760, and the process may loop back to step 710 or another step, depending on the nature and extent of consistency check failure.

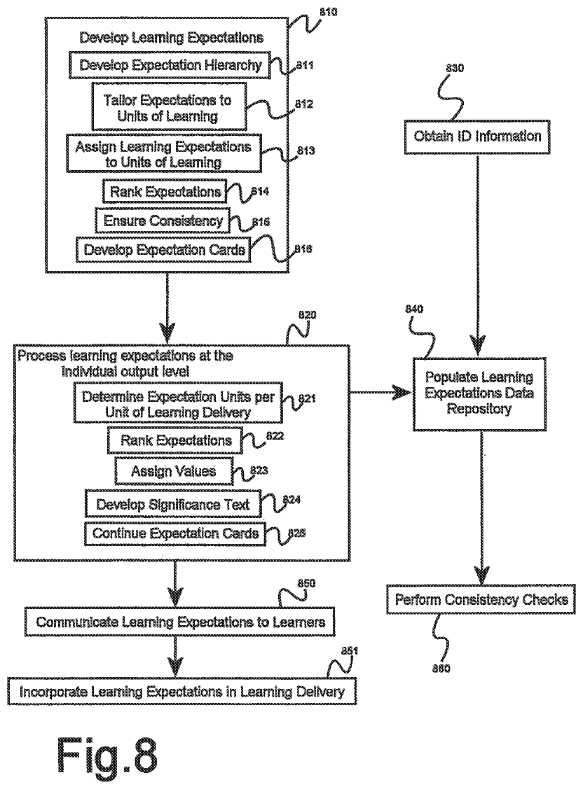

FIG. 8 is a process flow diagram illustrating a method 800 of establishing and using learning expectations, according to a preferred embodiment of the invention. Learning expectations may be set at various levels and units of learning in step 812, such as at institutional, college, course levels or on a per-module or per-lesson basis, or on a per unit of learning delivery or of learning output basis. Learning expectations represent what learning is planned and should take place in order to fulfill one or more learning goals. Learning expectations may commonly be hierarchical in the sense that they are set at various levels such as degrees, courses, modules, lessons, sessions, although they need not be (in general, learning expectations hierarchies will closely mirror corresponding goal hierarchies). In this sense, units of learning may be hierarchical. According to the embodiment, learning agents, agencies, learners, administrators, or other participants determine one or more overall learning expectations in high-level step 810. In general, specific expectations will be tailored to specific units of learning 812 and correspondingly assigned to one or more levels to create a hierarchy of learning expectations 812. In some embodiments, participants may rank expectations 814 based on a desired order of importance or relevance. In general, according to the embodiment expectations are made concrete and measurable, hence making objective learning assessment achievable. Learning expectations may decomposed into analytical units and assigned per levels, units of learning, such as degree, courses, years, sections, classes, modules, learning outputs, etc. Means and requirements to meet learning expectations at various levels and units of learning are developed. Categories of learning expectations may be selected, including for example analytical, communication, practice, etc. Means and requirements needed to satisfy categories of learning expectations may be developed, including for example learning materials, quizzes, tests, and assignments. Criteria may be developed to show how learners can achieve learning expectations. One or more scenarios of learning achievement or descriptions of success in meeting categories of learning expectations may be developed (for example, “all”, “some % of all”, “none”, “most”, “some”, and so forth). Numeric values are preferably assigned to expectations when appropriate, at levels and units of learning, to expectations categories, and scenarios of learning. Numeric values may include totals, absolute values, or percentages. Commentaries and recommendations may developed per levels and units of learning, per categories and scenarios of learning. One or more consistency checks 815 may be performed to ensure consistency of expectations and their quantitative breakdowns at various levels of expectations hierarchy. In some embodiments, expectations cards are developed in step 816 to enable participants to assess progress toward achieving one or more expectations easily.

Once expectations have been created and optionally assigned to a hierarchy in step 810, in step 820 one or more analytical criteria are defined that will be used in assessing progress in achieving expectations at various levels of a hierarchy. In step 821, expectations units are determined per unit of learning delivery, in order that later assessments may be carried out in an objective, quantitative manner. In step 822 one or more expectations may be ranked. In step 823, numerical values may be assigned to expectations at various levels in a hierarchy for the same purpose. In some embodiments, in step 724, one or more significance text data elements may be created, configured, or specified. For example, a significance text “This area needs significant improvement” may be specified for situations when certain expectations are only met at some predetermined level (say 70%) suitable for “passing” the expectation, but not by much. Finally, in some embodiments in step 825 development of expectations cards may be continued. In general, data (such as expectations, means, levels, formulas, etc.) created in these and subsequent steps may be stored temporarily in local memory, and is also generally stored in database 640, sometimes within a specific data repository (such as a learning expectations data repository) within database 640, although different data storage arrangements are possible according to the invention, as should be clear to one having ordinary skill in the art. Such data, as well as identifying information 830 such as information pertaining to learning agencies 731, learning agents 732, learning goals hierarchies 733, learning goals units 744, and learning delivery units 745, may be sent in step 840 to populate one or more learning expectations data repositories. Once learning expectations have been fully developed and means for achieving and assessing them identified, in step 850 one or more relevant learning expectations are communicated to applicable learners. Furthermore, in some embodiments, in step 851 one or more learning expectations may be incorporated into appropriate learning delivery vehicles (such as lesson plans, reading assignments, syllabi, and so forth). Again, as before, consistency checks may be performed in step 860 to ensure internal data consistency across expectations categories, learning levels, and levels of expectations hierarchies. When consistency checks fail, corrective steps may be taken as in step 760, and the process may loop back to step 810 or another step, depending on the nature and extent of consistency check failure.

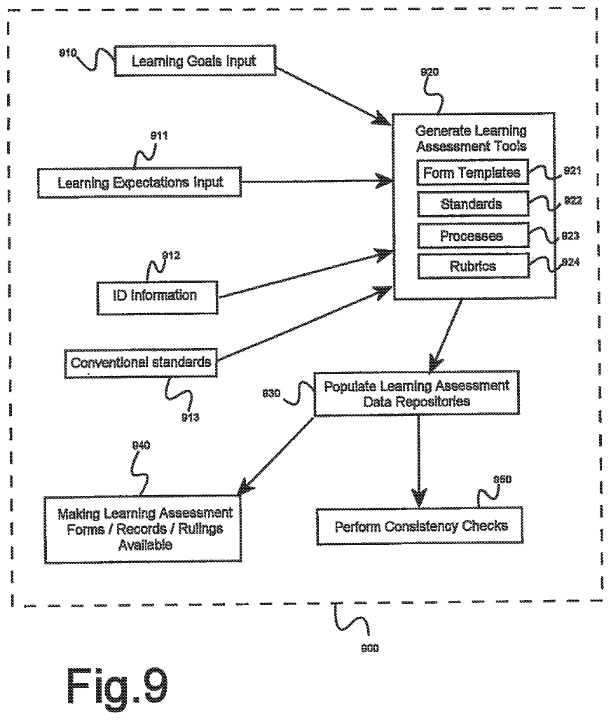

FIG. 9 is a process flow diagram illustrating an objective learning assessment method 900, according to a preferred embodiment of the invention. Inputs to method 910 may be taken from learning goals in step 911, learning expectations in step 920, identifier information in step 912, and conventional standards information in step 913. These inputs are used, in step 920, to generate learning assessment tools. Such tools may comprise, but are not limited to, assessment form templates 921, assessment standards 922, automated assessment processes 923, and assessment rubrics 924. Tools are provided in step 920 to allow assessments of learning performance per individual learners at the level of learning delivery and learning outputs. Assessment forms or rubrics at the output level provide learning goals metrics and in some embodiments learning expectations metrics for the level. They may offer goal categories and subunits, weight and values, criteria as items and or scenarios for example, numeric values in various formats, commentaries. They may comprise learning goals along with pertinent information such as learning goals and subgoals, categories, learning items, numeric values in one or more formats, conventional standards, analytical means and criteria, and so forth, at various levels of granularity relative to goals and expectations. Assessment forms and rubrics provide achievable values per learning goals and learning expectations units/subunits at all levels, per all categories, items, etc., down to the least subdivision, in required numerical and or conventional format. Assessment forms and rubrics may also provide total achievable values per subunits, categories, and learning items, as well as grand totals, as percentages or in whole or decimal numbers. Assessment spaces or slots may be provided for learning assessors to assess learning. These spaces are modeled upon learning goals and learning expectations at all levels, per all categories and learning items, etc., and are provided with numeric values, such as numbers, percentages, ranges, or with conventional standards, analytical means, explanations, commentaries, recommendations, or as scenarios with items to be learned. There may also be spaces provided for all subdivisions and grand totals for indicating achieved and missed learning. There may be spaces made available for assessors to make notes, write or communicate to learners, and so forth. Once learning assessment tools have been prepared in step 920, they are stored in learning assessment data repository 640 in step 930. As before, consistency checks may be performed in step 950 and other steps repeated as necessary to correct consistency problems. Finally, in step 940 learning assessment tools such as assessment forms, assessment rubrics, assessment records, and assessment rules are made available to learning agents online or in other media, such as an application on a mobile device for example, for use in assessing actual learning progress of learners.

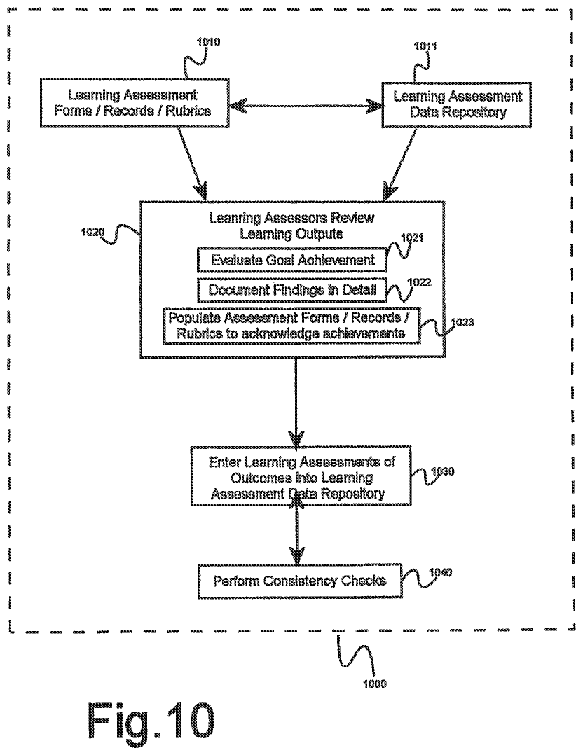

FIG. 10 is a process flow diagram illustrating a method 1000 of objectively assessing learning outcomes, according to a preferred embodiment of the invention. Starting with obtaining (in step 1010) learning assessment forms, records, or rubrics either directly from application server 630 or via step 1011 from data repository 640, in step 1020 learning assessors review individual learning outputs from learners (for example, exams, quizzes, assignments, papers, and so forth). In some embodiments, learning outputs are available directly online (as when, for example, learning is conducted directly online), while in other embodiments a learning assessor may either work directly with a learning output contained in written form on paper, or may import such a learning output into system 1000 using any of the many means available in the art for importing printed matter into online data repositories (for example, automated high-speed scanning and indexing). In some cases, learning outputs may be obtained in step 1011 from data repository 640. Once required assessment tools and learning outputs are on hand (such as rubrics or templates at the output level), assessors may in step 1021 evaluate achievement of one or more learning goals, categories, or units with the aid of the provided assessment tools. By using automated assessment tools with guidance, sample text for feedback to learners, and slots for assessments against specific learning goals and expectations in some embodiments, assessors are enabled to more efficiently, thoroughly, consistently, and objectively assess learning outcomes than using traditional grading means known in the art. In some embodiments, analysis engine 631 may perform preliminary analysis of one or more aspects of a learning output to provide further automated support for learning assessors. For example, analysis engine 631 may perform textual analysis of a learner's output to identify spelling and grammar errors and to quantitatively assess certain aspects of the selected output (e.g., automatic determination of average sentence length, average length in sentences per paragraph, accuracy of facts stated in the output, evidence of plagiarism from known or unknown sources, deviation of writing style or substance from statistical patterns previously exhibited by the specific learner, and so forth). Once an assessment has been conducted with automated support, in step 1022 assessment forms (records, templates, rubrics) at the output level are made available in a variety of ways. They may contain learning goals analytics. In some embodiments said records may contain learning expectations analytics. A learning assessor, using these forms, documents findings in detail by entering data and/or comments in various fields, spaces, or slots provided in the assessment tool being used. In some cases preliminary assessments may be made while electronically traversing a specific learning output (such as a term paper), and these may be used to automatically populate an assessment form, record, or rubric in step 1023 to acknowledge a learner's achievements. Results of learning assessments are entered, in step 1030, into learning assessment data repository 640, and consistency checks may be performed in step 1040. Consistency checks among learning assessment forms or rubrics and learning goals and learning expectations may be automatically conducted by or at the request of learning stakeholders, or learning agencies and agents. Assessors may mark or enter a scenario or item that the system then can associate with values. Learning expectations analytics may be used in some embodiments, for example assessors may identify evidence of achievement of learning expectations and populate learning assessment forms in order to recognize and acknowledge achieved learning of expectations.

Learning Assessment Forms/Rubrics at the individual learning output level contain, among others, pertinent identification information, learning goals units/subunits, categories, items (and weights of such units), numeric values representing achievable learning (in any desired/selected formats, to include but not limited to percentages, numbers, ranges, etc. or conventional standards), analytical means and criteria, spaces for achieved and missed learning (as desired/selected values as value), total achievable learning per each learning goal each subdivision (including but not limited to item, category, subunit, units), spaces/slots for total achieved and total missed learning per each learning goal subdivision, achievable learning grand totals, achieved and missed learning grand totals. There may be feedback at each subdivision level for achieved and missed learning. Learning expectations may be also available in assessment forms or rubrics, per each subdivision, to include values, means, criteria, and explanations (there are many choices regarding depth and number of levels of analysis regarding goal subdivisions). Typically, access to assessment tools is via a web browser, and may be gained from any location by any appropriately authorized user. The assessor (grader) reviews learners' learning output, using one or more learning assessment forms or learning assessment rubrics. The assessor appraises and acknowledges achieved learning per each subdivision of learning goals units/subunits and, if selected, learning expectations units/subunits. Assessors review learning output and assess it, reviewing analytical criteria and means achieved learning per goal categories and subdivisions, acknowledges achievement, rates learning outputs, and so forth, as desired or required.

According to the embodiment, assessment (grading) at the learning output level can be done in many ways, including but not limited to checking appropriate boxes, entering or selecting numbers, entering or selecting ranges, entering or selecting grades or any other conventional assessment indicators, selecting or entering percentages, and so forth, assigning numbers, assigning conventional standards, entering numbers, selecting for example achieved scenario, marking achieved items, clicking (marking, noting, or pushing) on scenarios items to document learning goals or expectations either achieved or missed (or both, in some cases), per all learning goal subdivisions (including units/subunits, criteria, scenarios, categories, subunits, items, parts, and so forth).). Any type of input may be related to formulas and calculations. For example, a learning assessor may select a conventional standard that is associated with numerical ranges. Criteria, scenarios, items may have numeric values. When a learning assessor marks an item or scenario (for example), that item or scenario may have numeric values. All assessment data produced in assessing learning outcomes based on goals, identifier information, learning goals metrics and weights, learning expectations metrics, and weights, learners' individual outputs are stored in data repositories.

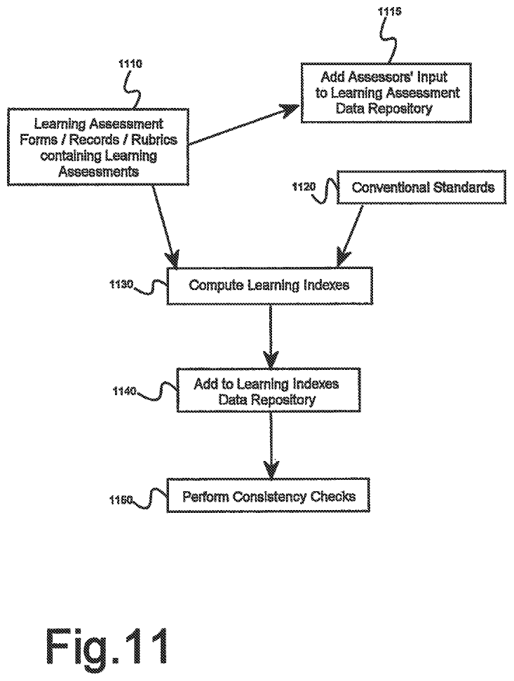

FIG. 11 is a process flow diagram illustrating a method 1100 of computing learning indexes, according to a preferred embodiment of the invention. Learning indexes represent learning achieved in relation to learning goals, in some embodiments in relation to learning expectations. Input to the process is from learning assessment forms, rubrics, or records generated by process 1000, in step 1110. Where not already done, in step 1115 assessors' inputs at individual learning output level are added to learning outcome data repository 640. Another input to process 1100 may comprise one or more conventional standards provided in step 1120 (for example, a standard schema for grades and their interpretation, expressed based on a percentage of achievement of overall learning goals and expectations). According to the embodiment, learning indexes are calculated in step 1130 for learning outcomes per individual learning output per individual learner (or teams or other groups, depending on a particular assignment, for example an individual output such as a project or presentations for example, may have been assigned to one or more learners, a team, a class, etc.) per each learning goal category, unit, or subunit, in various formats (to include numerical values such as percentages, whole numbers, decimal numbers, weights, etc., and qualifying texts, commentaries, etc.), and saved in data repository 640 along with ID information and goals analytics and weights and expectations analytics and weights. Learning indexes may be aggregated and compounded at any desired configurations, using weights, formulas and/or algorithms, and may be calculated per grading unit, per multiple unit of learner across multiple levels and units of learning, or per multiple units of learner across multiple levels and units of learning (or for any combination of these). Learning indexes may comprise totals (absolute amount) of learning achieved or accomplished, or percentages achieved, and as grand totals, as well as measures of missed learning (gaps), also generally expressed in numerical formats such as totals or percentages and as grand totals, and grades per category or final grades and ratings per units of learners and across multiple units and levels of learning. There are learning indexes of achieved learning and missed learning. Learning indexes as learning outcomes may comprise measures of learning or achievements of learning goals at various levels of granularity in terms of scopes, zones, learning spans, or organizations. Learning indexes per individual learner per unit of learning may comprise one or more learning outcomes expressed as totals achieved per scenarios or categories, percentages achieved per categories, grand totals (points) achieved per unit, grand totals achieved per learning unit, final grades, gaps of learning (missed learning), for individual output such as assignments, papers, presentations, and the like; assessments may be made per units such as class, module, sub section, section, course, as needed. Learning indexes may also be computed per individual learner across units and levels of learning such as for example courses, years, degrees, GPA, and so forth. When learning indexes are computed, they are added in step 1140 to learning indexes data repository 640 (again, data repositories may be combined or divided as desired, according to the invention, since the naming schemes used herein are for clarity only, disclosing particular logically-relevant data subsets as needed, any or all of which may be stored together or separately as desired). Finally, as in other processes disclosed herein, consistency checks may be performed in step 1150, and corrective actions may be taken as required by returning to affected prior steps to correct deficiencies in data consistency. Consistency checks can be conducted to ensure alignments among learning goals, learning expectations, learning assessment forms or rubrics, learning input or delivery, assignments, assessments, learning indexes, and the like, by learning stakeholders, learning agencies and agents.

Learning indexes of achieved and missed learning (as measured against learning goals or expectations) are always first calculated at the individual learning output (lowest) level per each goal subdivision; all other configurations can be calculated by aggregating learning results at the learning output level, taking into account the weights of each learning goal, subgoal, or expectation. To calculate achieved and missed (gap) learning indexes, learning indexes of total achieved goals or expectations per categories may be calculated, learning indexes percentage of goals or expectations achieved per categories may be calculated (achieved total/ideal total), and learning indexes gap totals may then be calculated (ideal totals—totals achieved) as well as learning indexes gap percentages (total gap/ideal total). Learning indexes grand totals can be calculated similarly. Calculations results can be expressed in many numerical formats as selected (to include percentages, whole decimal numbers, conventional standards, ranges) and texts or comments may be used. Any configuration and format can be calculated to show objectively achieved or missed learning in relations to learning goals. Calculations can be done across goals and within goals, across categories and within categories and their subdivisions. Totals across goals (such as per class or per learners during a session or a year, etc) can be decomposed into those of goal categories and their subunits. Calculations of learning outcomes learning indexes include multi levels of learners, including groups, sections, classes, years, sections, cohorts, peers, degrees, colleges, institutions, geographic areas across multi units and levels of learning including sections, classes, courses, degree, years, institutions, colleges, and so forth. Averages and weighted averages may be used to calculate learning indexes as achieved numeric values, such as totals, percentages, and gaps. Learning indexes may be aggregated to upper goals.

In some embodiments of the invention, method 1100 may calculate learning indexes at all learning goals subdivisions and, if selected, learning expectations subdivisions (units/subunits, starting with smallest categories, items, parts, means, criteria, and then compounding them to the highest levels). Learning indexes may be calculated first at the lowest subdivisions and then compounded to higher subunits and units of learning goals and learning expectations. They are often next (compounded) calculated at the unit of learning output, learning delivery, class, module, course, learner per class, per module, per course, in relation to learning goals units and learning expectations units, etc. Such learning indexes may be calculated as percentages, numbers, percentages of achievable totals, subtotals, totals per categories or across categories, ranges, grades or other conventional standards, etc., although indexes are not limited to this exemplary list.

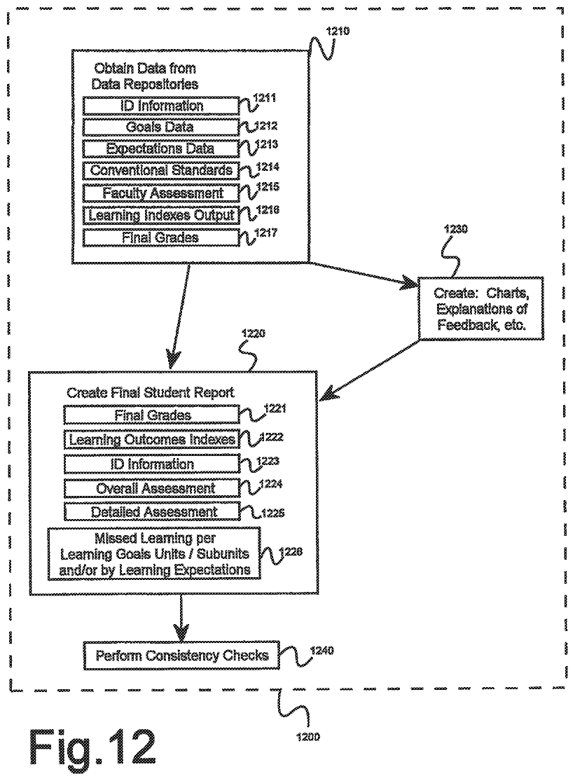

FIG. 12 is a process flow diagram illustrating a learning outcome reporting method 1200, according to a preferred embodiment of the invention. According to the embodiment, learning agents, agencies, institutions, etc select items of assessment learning outcomes for reports. Reports can include, among others, learning indexes of achieved learning, learning indexes of missed learning, output grades, at the unit of assessment of learning output. Reports may comprise final grades or other indicia of ratings of learning output, explanations of meanings of final grades or indicia, elements of achieved learning expectations and goals, including learning indexes achieved totals, percentages, grand totals, partial totals per goal categories, calculations per learning goals categories and subunits, across goals categories and subunits, learning gaps per and across learning goals categories, subunits, grand totals, partial totals, commentaries, explanations, per learning scenarios, categories, units of assessment. Reports may further comprise explanations, recommendations, commentaries, etc. pertaining to achievements of learning goals and expectations, missed learning as areas or opportunities for improvement, solutions to learning problems detected, any of which may be for one or more learning categories, units, zones, or levels. Reports may comprise charts, comparisons of achieved and ideal numeric values, commentaries or feedback of learning output, comparisons of learning indexes among learners in the same unit of assessment, and so forth. According to the embodiment, in step 1210 merged data from data repository 640, which as previously discussed could be a single data repository or a plurality of specialized data repositories or databases. Data gathered in step 1210 may comprise identifying information 1211, data pertaining to a plurality of learning goals and learning goal metrics 1212 at various hierarchical levels and at individual learning output level, data pertaining to a plurality of learning expectations and expectations metrics at the level of individual learning output 1213 also at various hierarchical levels, conventional standards (such as numeric or literal grades for example) 1214, faculty or other learning agent learning assessments inputs at the output level 1215 such as previous learning assessments pertaining to a specific learner or group of learners, learning indexes at output level 1216 from learning indexes computation process 1100, and other calculated items (such as, for example, totals, final grades, etc.) 1217 such as assigned grades for previous learning outputs. Grade and grade and feedback reports may comprise final grades, explanatory text regarding one or more meanings of the final grades, reports of achievement of learning goals and/or expectations, such as learning indexes achieved and missed (provided as totals and percentages per scenarios, categories, units, or levels of learning), commentaries, explanations, charts to illustrate achieved, missed, comparisons of learner learning indexes to group learning indexes, and so forth. Reports may provide recommended solutions for learning problems as well as assessment data. Using information obtained in step 1210, in step 1220 one or more final learning assessment reports is generated, each pertaining to a specific learner or group or class of learners. Learning assessment reports may comprise one or more of final grades 1221 such as for specific learning outcomes or for entire courses, programs, degrees, and the like, learning outcome indexes 1222, identifying information 1223 particularly for the specific learner to whom a specific report pertains (and to relevant learning agents, learning institutions, and so forth, as required). Generally, assessment reports will further comprise an overall assessment 1224 and a detailed assessment 1225; as would be expected, detailed assessment 1225 provides a more granular breakdown of assessment results by learning expectation and for all levels of learning scope, and thereby documents the basis on which overall assessment 1224 was made. In some embodiments, missed learning expectations 1226 are reported within assessment report 1220. Missed learning expectations 1226 documents any learning expectations that were not met by the specific learners to whom report 1220 pertains, and typically does so at various levels of granularity. That is, missed learning expectations 1226 may be documented any or all levels of learning goals, learning subgoals, and learning expectations. In most embodiments, charts may be create in step 1230 to visually display assessment results along with explanations of results, feedback for learners and other possible consumers of charts 1230, and so forth. Charts 1230 may comprise graphical representations of either achieved or missed learning in relation to learning goals and learning expectations, or both. Examples of visual elements that may be presented in charts 1230 may include, among others, grand totals per learning output, intermediate sub-totals per learning outcome, achieved and missed per learning goals and learning expectations categories, subdivisions, etc. of learning output, per individual and in comparison with peers in same group (such as class, section, team, and so forth), and trend lines to indicate whether a learner's performance is improving or deteriorating in one or more areas described above. As in other processes discussed above, consistency checks may be performed in step 1240. Consistency checks may be conducted to ensure alignment among learning goals, learning expectations, learning assessment forms, rubrics, and reports, learning input/delivery, assignments, assessments, learning indexes, learning assessment reports, etc., by learning stakeholders, learning agencies and agents. Learning assessment reports at the output level may be requested automatically or manually, by learning stakeholders such as learning agents (including administrators, staff, faculty, teaching assistants, and the like) or learning agencies (such as colleges, universities, institutions of learning, etc.). Learning assessment reports may be delivered to learners and or to groups of learners, who submitted said learning output as evidence of learning; they may be delivered in many ways, using media, browsers, PCs, laptops, can be printed, etc.

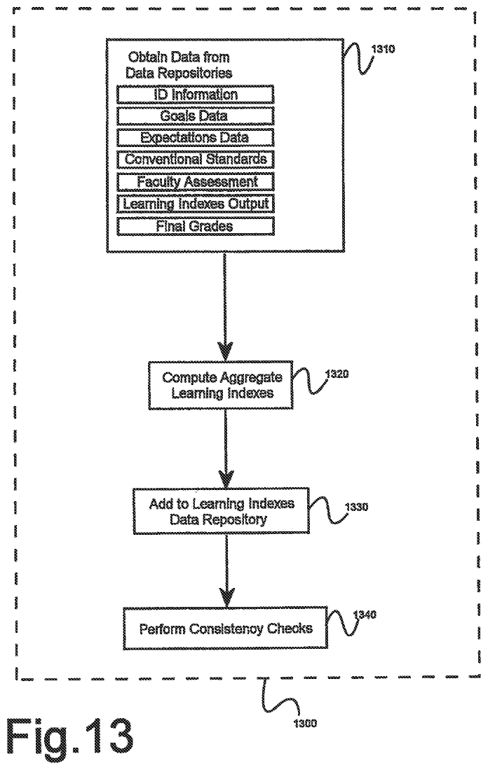

FIG. 13 is a process flow diagram illustrating a method 1300 of computing aggregate learning indexes, according to a preferred embodiment of the invention. As described above with reference to FIG. 12 (step 1210), in step 1310 required data may be obtained from data repositories 640. Some of the data may be identifying information, goals data, expectations data, conventional standards, assessor assessments inputs at the level of individual learning outputs, calculated values in various configurations, such as partial totals, percentages grand totals, grades, etc. Then, in step 1320, aggregate learning indexes may be computed and added, in step 1330, to data repository 640. Consistency checks may be performed in step 1340. Aggregate learning indexes 1320 reflect learning outcomes at multiple units, zones, or levels of learning (including in various combinations). They may be composed by aggregating reports of learning outcomes computed as learning indexes at the individual output level to other levels, units, zones, spans, and such. For example, as individual learners at multiple units, zones, or levels of learning, for instance by aggregating by section, class, course, year, degree, training, school year, school levels, including primary, high school, etc. Reports may display learning indexes as absolute numeric values, percentages, grand totals, partial totals, per goal, categories, etc. Reports may show individual learners' learning progress, achieved learning, missed learning, and/or they may show details of or recommendations for interventions to improve learning and to compensate for missed learning, as well as comparisons with other learners from same unit and level or other similar units and levels, such as section, class, course, section, degree, college, university, school levels, training module, course, institutions, geographic areas. According to the embodiment, learning agencies, institutions, administrators, and other users and stakeholders may have latitude to develop reports at multi units and levels of learning using systems according to the invention, such as a online learning assessment portal or an objective learning assessment application.

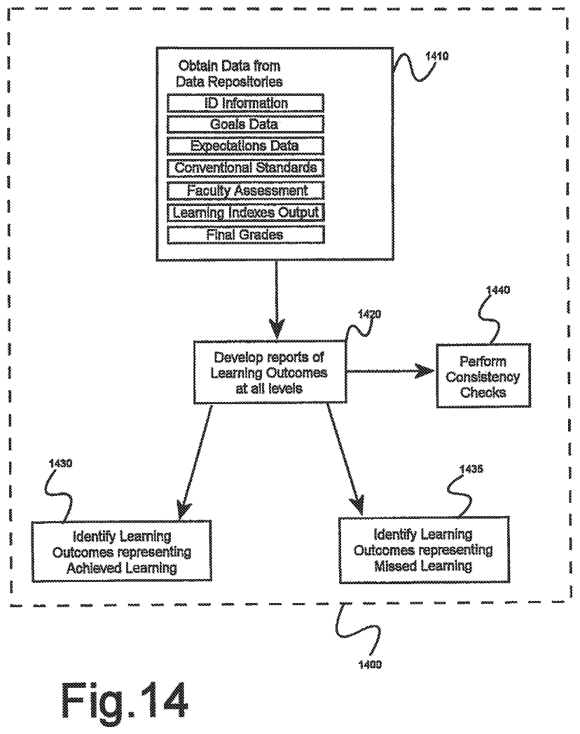

FIG. 14 is a process flow diagram illustrating an objective learning performance reporting method 1400, according to a preferred embodiment of the invention. As described above with reference to FIG. 12 (step 1210), in step 1410 required data may be obtained from data repositories 640. Then, in step 1420, reports of learning outcomes at all levels are prepared either automatically or on request from an authorized user such as a learning agent, an administrator, a member of an accreditation agency, or the like. Such reports may further identify learning outcomes representing achieved learning (that is, achieved learning goals or subgoals, or achieved learning expectations), in step 1430, and they may further identify learning outcomes representing missed learning (that is, missed learning goals or subgoals, or missed learning expectations), in step 1435. As before with other methods disclosed herein, consistency checks may be performed in step 1440. According to the embodiment, reports 1420 comprise reports of learning outcomes at multiple levels of granularity, such as for multiple units, zones, or levels of learning (including in various combinations). Specifically, reports 1420 may comprise reports of learning outcomes, learning indexes for multiple units of learners, such as sections, classes, years, levels, schools, institutions, geographic areas, across multiple units and multiple levels of learning, such as classes, years, degrees, institutions, geographic areas, etc. Learning indexes may show numeric values including achieved absolute totals, grand totals, missed absolute totals, grand totals, and percentages. Reports may show progress of multiple units of learners, such as classes, years, sections, cohorts, colleges, institutions, at any or all units and levels of learning. Reports may also show learning progress and improvements, before and after learning interventions, in order to enable an assessment of the effectiveness of such learning interventions. That is, using individual learning indexes at the learning output unit, the system may calculate learning indexes of learning outcomes (of achieved and missed learning in relation to learning goals) and, if desired, learning expectations, in all configurations, including but not limited to all learning levels, units, spans, groups, zones, historical progressions, for all learners and any groups of learners, all learning agents, agencies, across levels, units, groups, historically, geographically, per learning stakeholders, etc. Reports assembled according to method 1400 thus may provide objective assessments of learning indexes of achieved or missed learning in any or all available configurations, particularly with respect to their relationships to established learning goals and learning expectations. Method 1400 enables reconstruction of learning goals up the hierarchical path, and reports 1420 may thereby illustrate achieved and missed learning in relation to learning goals at all levels of its hierarchy per all configurations. Examples of such reports 1420 may comprise, for example, reports of results per learner per examination, per learner per class, per learner per section, per learner per degree, per class per instructor, per class per year, per college overall, per college over years or other time periods, per degree programs over years or other time periods, per geographic zones, per historical spans, per countries, regions, or continents, and per cross-sections of identical or related courses across a county, region, country, cross comparisons among colleges, at any levels, zones, and so forth. Benchmarking reports may be developed at various configurations of achieved and missed learning.

According to the embodiment, learning stakeholders, such as learning agencies and agents, may cause reports 1420 to be prepared and delivered on demand or automatically per fixed schedules. Furthermore, ad hoc reports may be requested by authorized users, for example when an assessment of a one—time learning intervention is desired. Learning stakeholders, including but not limited to learning agencies and agents, such institutions, colleges, schools, faculty, administrators, deans, staff, IT, and so forth may generate or configure reports 1420 as allowed by their respective access permissions. Learning stakeholders, such as accreditation bodies, policy makers, the Department of Education, parents, communities, employers, learners, etc. may request preparation or delivery of reports 1420, including specialized reports 1430, 1435, as needed in order to confer or deny accreditation, grants, develop new policies, improve teaching staff, develop/improve learning materials, learning methods, etc., hire for required skills, ensure education takes place and learners can contribute to society.

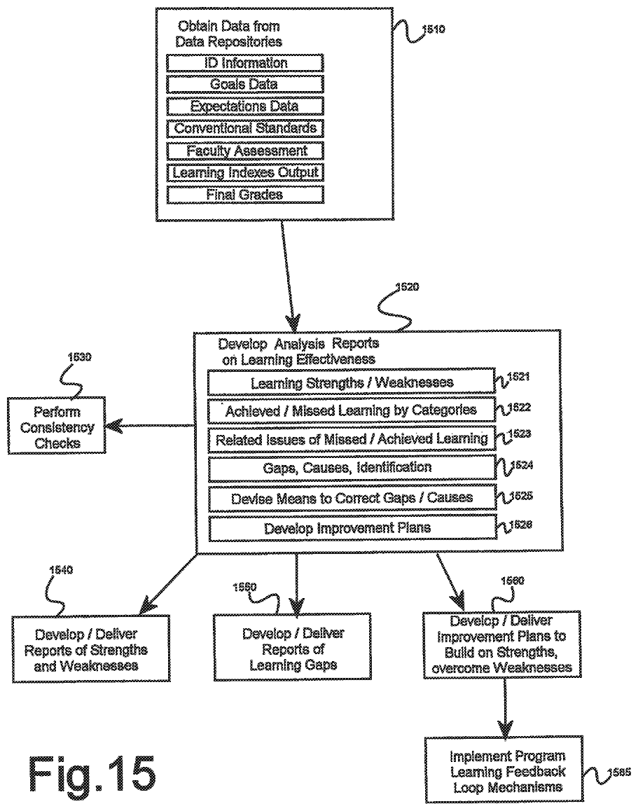

FIG. 15 is a process flow diagram illustrating a learning improvements reporting method 1500, according to a preferred embodiment of the invention. As described above with reference to FIG. 12 (step 1210), in step 1510 required data may be obtained from data repositories 640. Then, in step 1520, analysis reports 1520 regarding learning effectiveness are prepared. Such reports may comprise one or more of: lists 1521 of learning strengths and learning weaknesses; lists 1522 of achieved and missed learning organized by various categories, hierarchical levels, and the like; lists 1523 of related issues pertaining to missed or achieved learning (for example, an item might note that similar reading comprehension “misses” occurred in each learning unit, indicating a likely general problem with reading comprehension, rather than difficulty comprehending reading on a specific topic or poorly performed or designed assignments when comparing achieved and missed learning in units with different assignments for same topic and same goals); lists 1524 of learning gaps and their causes; lists 1525 of one or more means to correct identified gaps or their causes (for example, an item that suggests extra reading in a certain subject area to address level of knowledge gaps therein); and one or more improvement plans 1526 developed in order to address one or more shortcomings in achieved learning. As before, in step 1530 consistency checks may be performed if desired to ensure alignment among learning goals, learning expectations, learning indexes, configurations, reporting configurations, and so forth, whether by learning stakeholders, learning agencies and agents. to ensure alignments among learning goals, learning expectations, objective learning assessment forms, reports, and rubrics, learning input/delivery, assignments, assessments, learning indexes, learning interpretations, and the like, by learning stakeholders, learning agencies and agents. Then, in step 1540, one or more reports of strengths and weaknesses of specific learners or sets of learners may be developed and delivered to appropriate stakeholders. In step 1550, one or more reports of learning gaps of specific learners or sets of learners may be developed and delivered to appropriate stakeholders. In step 1560, one or more improvement plans intended to build on learners' strengths and to overcome their weaknesses may be developed and delivered. Then, in step 1565, improvement programs and learning feedback loop mechanisms may be implemented. In more detail, in step 1520 one or more learning stakeholders such as learning agents, agencies, or institutions may analyze reports of achieved and missed learning at multiple units of learners and multiple units and levels of learning or analyze various benchmark reports in order to understand using objective data where learning processes are working and where they are not, in order to develop effective action plans in step 1560. For example, learning agencies, agents, or institutions may elect to make changes to learning means, such as for example teaching materials, teaching methods, learning assignments, learning practice techniques and requirements, and so forth, in order to address one or more missed learning goals.

As a further example, at an individual leaner's learning output level, feedback reports interpret learning outcomes at all units/subunits of learning goals, explaining which skills are acquired and which are missed or need improvement, may be prepared in step 1520. Cross-comparison further enables interpretation of learning achieved in comparison with other learners. Analysis of learning outcomes, as achieved and missed learning, in relation to learning goals and expectations, can explain what goals and expectations have been met (and to what extent they have been met), what the significance of learning outcomes is, what knowledge, skills, areas of expertise have been acquired, and so forth, at all configurations. For example, one can analyze which skills are mostly acquired or missed by a learning group such as a class or cohort, a county, and so forth. Learning stakeholders, such as learning agents, agencies, learners, accreditation bodies, employers, policy makers, communities may each benefit from analysis and interpretation of learning outcomes. Analysis and interpretation of learning outcomes may be done by learning stakeholders with access to data and reports 1520 of achieved and missed learning in relation to learning goals and expectations at respective configurations. Learning agencies and agents, including but not limited to, faculty, assessors, administrators, researchers, colleges, universities, etc. analyze learning outcomes using systems according to the invention in order to interpret learning achieved and missed in relation to planned learning (i.e., learning goals and expectations) in many configurations, including but not limited to individual learning output, class, one or groups of learners, module, year, degree, cohort, etc. Other learning stakeholders such as learners may analyze learning based upon learning assessment reports, for example at the output level, module level, class level, etc. They can also request ad hoc analysis at other levels in order (for example) to rate a learning agency they plan to attend. Accreditation agencies typically need to assess learning at learning agencies and to compare them. Hiring organizations need to know whether skills they need have been effectively learned. Policy makers, state and federal bodies, regulators, grants issuers, state or federal boards, etc. can also request and use interpretation of learning.

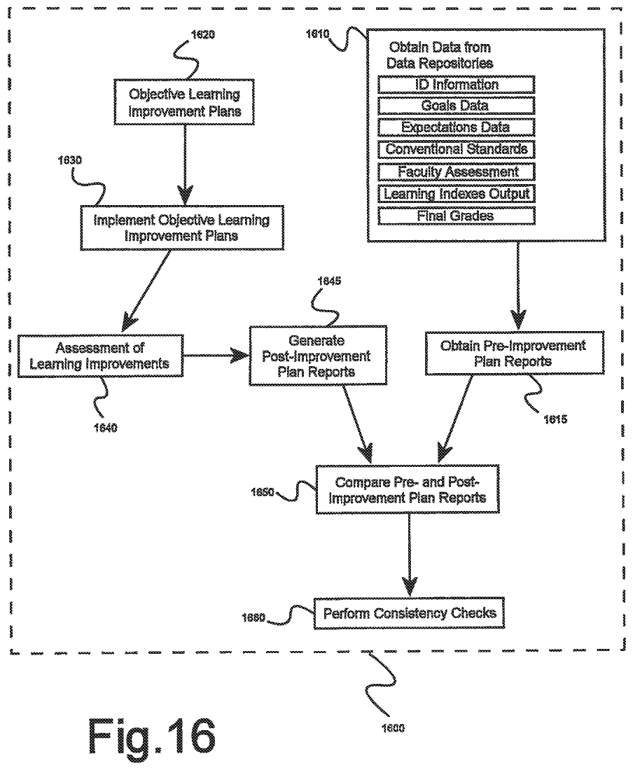

FIG. 16 is a process flow diagram illustrating a learning improvements implementation method 1600, according to a preferred embodiment of the invention. As described above with reference to FIG. 12 (step 1210), in step 1610 required data may be obtained from data repositories 640. Also, in step 1620 objective learning improvement plans may be received as inputs to method 1600. Then, in step 1630, one or more objective learning improvement plans are implemented and in step 1640 ongoing assessment of learning improvements is performed automatically or on request. Based on this ongoing assessment of learning improvements 1640, in step 1646 post-improvement plan assessment reports are generated. Similarly, in step 1615 pre-improvement plan assessment reports are retrieved from data repository 640. Then, in step 1650, pre- and post-improvement plan assessment reports may be compared to identify whether, and how effectively, improvement plans implemented in step 1630 are achieving their objectives. It can be seen that this automated learning improvement process can facilitate not only improved learning outcomes for learners, but improvements in learning delivery processes driven by identified strengths and weaknesses of implemented improvement plans. Again, in step 1660 consistency checks may be performed as desired to ensure alignment of improvement plans with and among learning goals, learning expectations, objective learning assessment forms, reports, and rubrics, learning input/delivery, assignments, assessments, learning indexes, learning indexes at configurations, assessment reports at configurations, and so forth, by learning stakeholders, learning agencies and agents.

In general, reports of missed and achieved learning at all units and levels identify strengths and weaknesses as areas of improvement, at all levels, units, spans, zones, etc. Examples include but are not limited to individual learners, instructors, colleges, schools, groups of learners at any unit or level, geographic areas, etc. Learning improvement programs are developed and implemented in order to maintain and to build upon strengths and to manage and to overcome weaknesses, specifically via providing learning feedback loops. Method 1600 develops learning improvement programs, comprising tools to measure learning achieved and missed in all configurations as well as improvement plans (for example, but not limited to, pre and after intervention learning assessment reports). Progress (achieved learning) and lack thereof (missed learning) may be examined in various configurations and times in the program, which can use learning improvements in learning feedback loops. All learning stakeholders have a strong interest to improve learning. Learning agencies and agents may use data and learning assessment reports of learning outcomes to determine causes of missed learning and to develop plans of improvement. Learning agencies and agents, including but not limited to administrators, faculty, deans, staff, colleges, schools, learners, and the like, may use various systems and methods of the invention, disclosed herein, to automatically or manually identify weaknesses and strengths, seek and identify their likely causes, develop programs to overcome weaknesses, and then implement them. They can use pre and post reports per program and if successful implement it more permanently. These results can be shared with all interested stakeholders.

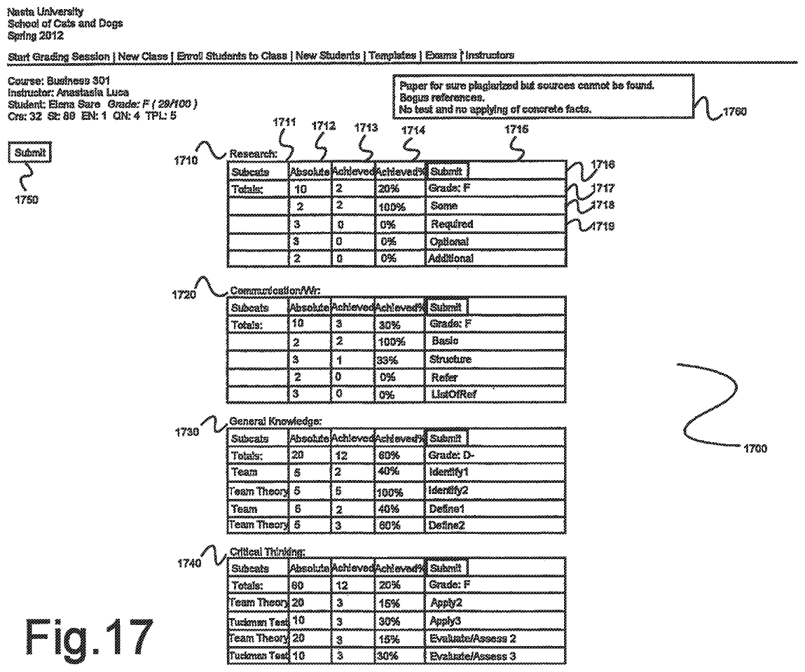

FIG. 17 is a diagram of an exemplary online or electronic assignment-grading tool 1700, according to a preferred embodiment of the invention. According to the embodiment, tool 1700 may be delivered online via an architecture such as that shown in FIG. 6, or it may be delivered via a stand alone application that is connected (either continuously or as needed) to database 640 via a network; various application formats may be used according to the invention, including but not limited to “thick client” applications, plug in modules for use with commercial spreadsheet or word processing software, mobile or tablet applications, such as those distributed via the Apple AppStore™ or the Google Android™ marketplace, and so forth. It should be appreciated by one having ordinary skill in the art that any suitable application type may be used according to the invention, and that the visual appearance shown in FIG. 17 is intended merely to be exemplary of a graphical user interface for accomplishing certain goals of the embodiment, and any other suitable user interface choices capable of delivering similar functionality may be used without limitation. According to the embodiment, in general learning goals are arranged in tables 1710, 1720, 1730, 1740 according to category (i.e., learning goal type), and individual subcategories may be arranged on individual rows within goal category tables; each row typically will have a subcategory label in a first column 1711, absolute (or percentile, as desired) values of maximum scores for a given subcategory (that is, column 1711 lists maximum scores for each subcategory), actual scores achieved in a second column 1712, percentage of maximum achieved in a third column 1713, and explanatory text for each subcategory in a fourth column 1715. Other columns may of course be added as desired, for example to show class assignments, prior scores, r to provide a text entry field within which a learning assessor make comments. Typically, for each goal category, a first row 1716 presents header information and may comprise a “SUBMIT” button to allow a user to commit a set of category-specific marks to data repository 640 (overall “SUBMIT” button 1750 performs the same function, but commits all learning goal grades entered to data repository 640. A second row 1717 may be provided that presents totals for each column within a given learning goal category; fields in this row are typically populated automatically by programmatically adding the corresponding values from rows 1718-1719 that comprise actual goal-specific grades data.

For example, considering table 1710 representing learning goals relating to “Research”, row 1717 comprises automatically populated data pertaining to a maximum total score for the category (10; units could be “points” or any other suitable units, or the numbers could be considered unitless), of which the specific learner in question (“Elena Sare”) received only 2 points for a total average on the category of 20%, resulting in a grade for the category of “F”. The learner obtained 2 (out of 2 possible) points for a first goal in the category, which has the explanatory text “Some”, meaning “showed evidence of doing some research”. She obtained no points for the following three goals, which represent “showed evidence of doing all required research” (3 points possible), “showed evidence of doing some optional research” (3 points possible), and “showed evidence of doing additional research” (2 points possible). The scoring arrangement shown in table 1710 is one exemplary “style” of grading, wherein each goal represents a further level of achievement, and their weightings correspond to their relative importance. Similarly, table 1720 shows an arrangement for a learning goal category of “Communications”, wherein each goal represents a specific aspect of communication and provides a score that the learner achieved on that particular aspect, without regard to how she performed on any of the other aspects. For the learner whose performance illustrated in FIG. 17, 2 of 2 points were awarded for basic communications techniques used, 1 of 3 for the structure of a learning output (likely a paper or a set of essay questions), 0 of 2 for using references appropriately, and 0 of 3 for providing a required list of references. Another exemplary style of grading is shown in table 1730, wherein each goal represents a concrete learning deliverable. For example (and as illustrated in FIG. 17), the learner achieved a score of 2 out of 5 on a first goal tied to identifying some specific facts demonstrating knowledge of a topic “Team”, 5 out of 5 on a second goal of identifying some other specific facts regarding topic “Team Theory”, 2 out of 5 on providing definitions for “Team” concepts, and 3 out of 5 for providing definitions for “Team Theory” concepts. Similarly, table 1740 illustrates a grading scheme based on assessing specific deliverables tied to different topics. These varied examples are intended to be illustrative of an overall approach to online or application-assisted grading, and are not exhaustive; any hierarchical grading scheme for assessing overall achievement of learning goals may be used according to the embodiment. Grading form 1700 also provides a space 1750 for assessor comments; in some embodiments a plurality of such spaces may be provided, such as by providing a comment entry block for each goal category or for each individual goal.

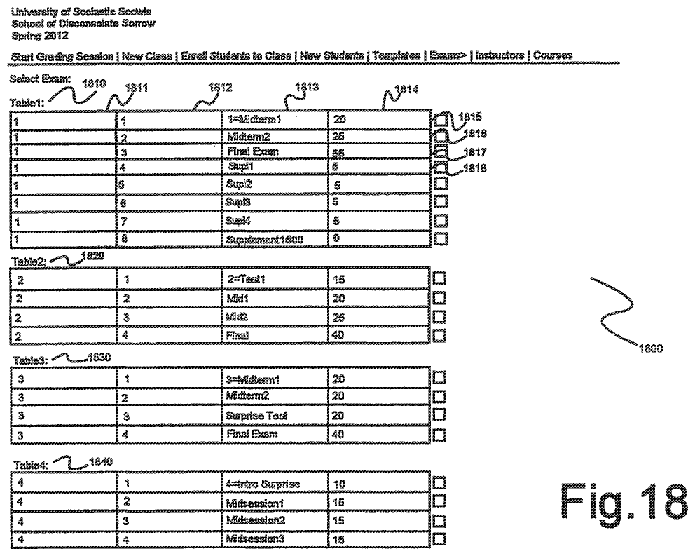

FIG. 18 is a diagram of an online course-grading tool 1800, according to a preferred embodiment of the invention. According to the embodiment, tool 1800 may be delivered online via an architecture such as that shown in FIG. 6, or it may be delivered via a stand alone application that is connected (either continuously or as needed) to database 640 via a network; various application formats may be used according to the invention, including but not limited to “thick client” applications, plug in modules for use with commercial spreadsheet or word processing software, mobile or tablet applications, such as those distributed via the Apple AppStore™ or the Google Android™ marketplace, and so forth. It should be appreciated by one having ordinary skill in the art that any suitable application type may be used according to the invention, and that the visual appearance shown in FIG. 18 is intended merely to be exemplary of a graphical user interface for accomplishing certain goals of the embodiment, and any other suitable user interface choices capable of delivering similar functionality may be used without limitation. According to the embodiment, tables 1810, 1820, 1830, 1840 each represent a specific course of instructions grading system. For example, table 1810 represents learning outcomes that are assessed or graded individually and then used to generate an overall course grade based on the individual learning outcome assessments (which typically are weighted, when computing an overall course grade, based on the degree of importance assigned to each learning outcome; weights are shown in this example in column 1814). Column 1810 provides, for each row (for example, rows 1815-1818) an identifier specifying which course (or table) the particular row pertains to (in FIG. 18, it will be appreciated that this data is redundant, since each row appears only in the table corresponding to the value in its column 1811), but in some embodiments various views may be presented that mix rows from different tables. Column 1812 provides a counter value for each row within each table. Column 1813 provides a text description of the specific learning outcome to which a row pertains, and column 1814 displays a weighting factor applied to that row when computing overall course grades. Weighting factors in column 1814 may be expressed as integers or as percentages (when expressed as integers, each row is weighted on a pro rata basis, by multiplying its score by the weighting factor divided by the sum of all weighting factors for that course). Thus for example the course shown in table 1810 comprises two midterms in rows 1815 and 1816, wherein the first midterm is contributes 16.7% of the overall grade (20/120, where 120 is the sum of values in column 1814 of table 1810), and the second midterm contributes 20.8% (25/129); it further comprises a final examination (row 1817) worth 45.8% of the course grade and four supplementary learning outcomes (one of which is shown as row 1818), each worth 4.2% of the course's overall grade. In some embodiments of the invention, a learning assessor may select one or more learning outcomes by selecting appropriate checkboxes on the right, and then may grade those learning outcomes, with the resulting grades being stored in data repository 640 and being used to generate course grades in accordance with its assigned weight. It should be noted that each learning outcome may contribute to the fulfillment of a plurality of learning goals and learning expectations, each of which may in turn depend on results achieved across a plurality of learning outcomes to generate an overall assessment score. For example, if one learning goal is to develop facility with critical analysis in written outputs such as papers and essay questions on exams, then satisfactory achievement of the goal can be measured by assessing appropriate objective factors that contribute to subordinate or partial scores for particular learning outcomes (as shown in FIG. 17), so that each assessment carried out using FIG. 17 may influence final scores for a variety of learning outcomes, course grades, learning goals, learning expectations, and so forth.

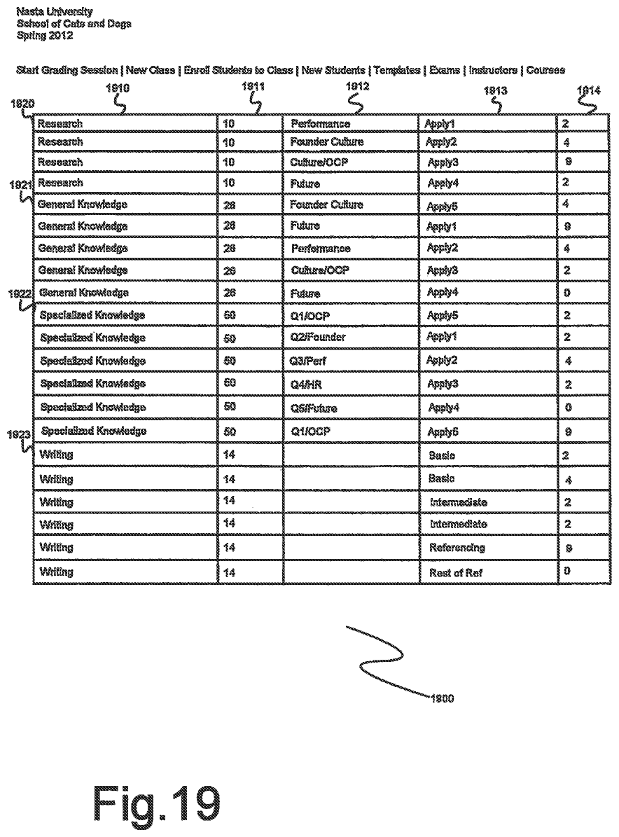

FIG. 19 is a diagram of an online tool 1900 for managing learning expectations, according to a preferred embodiment of the invention. According to the embodiment, tool 1900 may be delivered online via an architecture such as that shown in FIG. 6, or it may be delivered via a stand alone application that is connected (either continuously or as needed) to database 640 via a network; various application formats may be used according to the invention, including but not limited to “thick client” applications, plug in modules for use with commercial spreadsheet or word processing software, mobile or tablet applications, such as those distributed via the Apple AppStore™ or the Google Android™ marketplace, and so forth. It should be appreciated by one having ordinary skill in the art that any suitable application type may be used according to the invention, and that the visual appearance shown in FIG. 19 is intended merely to be exemplary of a graphical user interface for accomplishing certain goals of the embodiment, and any other suitable user interface choices capable of delivering similar functionality may be used without limitation. According to the embodiment illustrated in FIG. 19, each row corresponds to a discrete learning expectation; these expectations may be (as they are in the example shown) according to learning goal categories such as research 1920, general knowledge 1921, specialized knowledge or skills 1922 (such as analytical skills, critical thinking skills, and the like), and writing 1923 (of course, any number of goal categories, or of higher-level learning expectations or expectation categories, may be used according to the invention, with these four being merely exemplary). For each row (expectation), a first column 1910 provides an appropriate categorization, a second column 1911 provides a numerical value representing an aggregate weighting factor for the particular category (for example, “Research” 1920 is weighted 10, while “General Knowledge” 1921 is weighted 25), a third column 1912 provides a label for the goal, a fourth column 1913 provides a supplementary label or attribute (or, in the case of the writing expectations, it is the main label, as the third column is empty for those rows), and a fifth column 1914 a weighting to the particular row within the specific category to which it belongs (for example, “Performance” counts 11.8% (2 of 17) of the “Research” 1920 goal. It should be appreciated that the specific number and arrangement of columns shown in FIG. 19 is merely exemplary, and more or fewer columns may be shown in various embodiments of the invention. It should be appreciated that the items shown in FIG. 19 are exemplary, and any of a wide range of other topics/items could be listed, based on previously established learning goals or learning expectations.

It should be understood by one having ordinary skill in the art that the system and

methods described above are exemplary, and that many variations exist beyond those described in detail above. For example, in an embodiment at least some learning outputs are assessed entirely automatically, and some may be initially assessed using automated techniques and then submitted to a human learning assessor for a follow on learning assessment. Methods of automation of learning assessment may comprise, but are not limited to, methods such as automatically (using for example a special purpose computer program) analyzing written learning output for spelling, grammar, factual, and or stylistic errors. Quantitative assessment of textual learning output to determine text-specific indexes (such as average number of words per sentence, degree to which active voice is used, average number of sentences per paragraph, variability in number of sentences per paragraph, repetitive use of one or more words in close proximity to each other, and so forth). In some embodiments, patterns identified by human learning assessors may be automatically or manually entered into a rules database so that automated means may be used in future assessments to detect the same or a similar pattern; such detection of previously-identified patterns may be performed conclusively (that is, a grade or quantitative assessment is actually adjusted automatically) or suggestively (that is, a detected pattern is highlighted or otherwise marked to draw the attention of a human learning assessor, in order to facilitate thorough, consistent, and efficient learning assessments).

In various embodiments, users interacting with systems or using methods of the present invention may do so using a web browser (the approach illustrated above in FIG. 6), a dedicated software application operating on a personal computer, laptop or other computing device and at least intermittently connected to data repository 640, a mobile application operating on a mobile device and connected at least intermittently to data repository 640 over the Internet 601 via one or more physical networks such as a wireless telephony network, a kiosk located at an educational institution adapted for use by learners, or even an “all in one” software application in which all elements of a system similar to that shown in FIG. 6 (including for example data repository 640) are provided in one application operating on a computing device such as a personal computer (in such cases, there may be a master data repository 640 at a central location that receives updates of learning outcomes and learning assessments accomplished from a plurality of such “all in one” applications, and which may provide consistency rules, goals, expectations, assessment forms, and the like for download by each of the plurality of “all in one” applications). Thus it should be clear that methods of the claimed invention may be carried out in offline situations, and therefore that the system and methods of the invention are not limited in any way to online embodiments.

One application may be for the system, or components of it in various embodiments, to be used as a platform application on existing platforms in institutions of learning. It could be a separate application. The grading tool embodiment could be used by individual assessors, such as graders, faculty, etc.

The skilled person will be aware of a range of possible modifications of the various embodiments described above. Accordingly, the present invention is defined by the claims and their equivalents. Moreover, many embodiments have been described in detail herein for purposes of illustration and example, but it should be understood that these embodiments could be combined in many ways, and it is generally envisioned by the inventor that many implementations of the invention would combine a plurality of embodiments described herein. The inventor expressly notes that the invention is not limited to any particular embodiment or combination of embodiments, but that these may be combined in any way consistent with the invention as claimed.

What is claimed is:

1. A system for objective assessment of learning outcomes, the system comprising:
a computing system comprising a processor and a memory;
a data repository operating on a network-connected server and comprising at least a hierarchical arrangement of a plurality of learning goals the attainment of which is measurable quantitatively, a plurality of data consistency rules, and a plurality of learning outcome assessment forms;
wherein programming instructions stored in the memory and operable on the processor cause the computing system to:
operate a report generator subsystem coupled to the data repository;
operate an analysis subsystem coupled to the data repository;
operate a rules subsystem coupled to the data repository; and
operate an application server subsystem adapted to receive application-specific requests from a plurality of client applications and coupled to the data repository;
wherein the application server is further adapted to provide an administrative interface for viewing, editing, or deleting a plurality of learning goals and relationships between them, learning assessment tools, learning outcome reports, and learning indexes;
wherein the rules engine performs a plurality of consistency checks to ensure alignment between and among learning goals, learning assessment tools, learning outcomes, and learning indexes;
wherein the application server receives learning assessment data over a network;
wherein the analysis engine conducts automated analysis of received learning assessment data and relevant rules to compute a plurality of learning indexes; and
wherein the report generator generates and distributes learning outcome reports using the learning assessment data and the learning indexes.

2. The system of claim 1, wherein the application server is further adapted to provide a learning assessor interface that receives requests for learning assessment tools from learning assessors, sends requested learning assessment tools to requester in the form of a data object, and receives learning assessment data from the requester during or following an assessment of a learning outcome by the learning assessor.

3. The system of claim 2, wherein at least a portion of an learning assessment is performed automatically by the analysis engine and results of such automated analyses are included in the data object comprising the learning assessment tools.

4. The system of claim 1, wherein the application server interacts with users via a web server.

5. The system of claim 1, wherein the application server interacts with users over a wireless telecommunications network.

6. The system of claim 1, wherein the learning indexes comprise quantitative analytical measures of achieved learning and missed learning per units of learning goals.

7. The system of claim 6, wherein learning indexes are generated for a plurality of individual learners.

8. The system of claim 6, wherein learning indexes are generated for a plurality of aggregates of individual learners, assembled based on membership of individual learners in one or more learning units, zones, or levels.

9. The system of claim 6, wherein the learning indexes are used to generate grade reports with feedback for learners.

10. The system of claim 8, wherein the report generator generates and distributes reports based at least in part on the aggregated learning indexes, the reports identifying areas of achieved and missed learning relative to established learning goals.

11. The system of claim 10, wherein the analysis engine performs analysis of a plurality of learning indexes or learning outcome reports, or both, pertaining to a learner and prepares thereby and distributes a learning improvement plan tailored to the learner.

12. The system of claim 11, wherein the analysis engine automatically analyzes progress of the learning improvement plan and, based at least on comparing learning outcome assessments from before and from after implementation of the learning improvement plan, adjusts the learning improvement plan or prepares and distributes a new learning improvement plan.

13. The system of claim 2, wherein the application server interacts with a dedicated grading application.

14. A learning assessment application comprising a user interface that retrieves one or more preconfigured learning assessment tools from an application server via a data network and adapted to enable a user to perform an assessment of a learning output to determine a level of achievement of a plurality of learning goals maintained by the application server; wherein the application, upon completion of the assessment, sends to the application server at least a plurality of numerical assessment results corresponding to the plurality of learning goals.

15. A method for objective assessment of learning outcomes, the method comprising the steps of:
providing an administrative interface via an application server to allow users to specify a plurality of learning goals;
decomposing at least a portion of the learning goals into achievable and measurable analytics units;
organizing the learning goals into a hierarchy;
automatically performing consistency checks to ensure alignment of learning goals align the hierarchy;
providing a plurality of learning assessment tools to a learning assessor in one of online, mobile application, or thick client application formats;
receiving learning outcome assessment data at the level of individual learning outcomes from the learning assessor;
calculating learning outcomes as learning indexes at the level of an individual output; and
preparing and distributing a plurality of learning outcome reports for the individual learner.

16. The method of claim 15, further comprising the steps of:
aggregating a plurality of learning indexes calculated at the level of individual learners into a plurality of learning indexes at multiple levels of units, zones, levels, and the like; and
preparing and distributing a plurality of learning outcome reports based on the plurality of aggregated learning indexes.

17. The method of claim 16, further comprising the steps of:
preparing and distributing a learning improvement plans to enable a specific learner to either overcome weaknesses indicated by missed learning, or build on strengths indicated by achieved learning, or both;
automatically monitoring progress of the learning improvement plan; and
based at least on comparing learning outcome assessments from before and from after implementation of the learning improvement plan, adjusting the learning improvement plan or preparing and distributing a new learning improvement plan.

18. The method of claim 16, wherein at least a portion of a planned learning assessment is performed automatically, and its results delivered with an applicable learning assessment tool.

19. The system of claim 16, wherein at least some learning assessments are completed automatically, and wherein the automatically completed learning assessments are delivered as learning assessment tools to allow learning assessors to review and comment on the automatically generated learning assessment.
